(19) United States
(12) Patent Application Publication
(10) Pub. No.: US 2015/0170157 A1
(43) Pub. Date: Jun. 18, 2015

(54) System and Method for Brokering the Publication of Media Content

(71) Applicant: 2308134 Ontario Inc., Toronto (CA)

(72) Inventors: Ron MOORE, Toronto (CA); Brian L. FRENCH, Toronto (CA)

(73) Assignee: 2308134 Ontario Inc., Toronto (CA)

(21) Appl. No.: 14/105,588

(22) Filed: Dec. 13, 2013

(51) Int. Cl. G06Q 30/00; G06Q 50/18

(52) U.S. Cl. CPC G06Q 30/018; G06Q 50/184

(57) ABSTRACT

A system and method are provided for enabling the publication of media content. The method comprises enabling a producer of media content to post at least one media item to an online platform; providing access to the at least one media item via the online platform to at least one publisher registered with the online platform; receiving a request from a publisher to obtain rights to a particular media item posted by the producer; and enabling the publisher and the producer to perform a transaction transferring the rights to the particular media item from the producer to the publisher using the online platform.

### TECHNICAL FIELD

The following relates to systems and methods for brokering the publication of media content.

### DESCRIPTION OF THE RELATED ART

Media outlets such as newspapers and news broadcasters have been challenged in recent times due to several factors, including, without limitation, relatively high fixed overheads, lower revenue with the demand for free digital editions, and the growth of alternative digital advertising options for traditional businesses.

Part of the relatively high fixed overheads can be in paying for journalistic talent to generate news and other media content. In response, some media outlets have begun to buy content from news bureaus such as the Associated Press (AP), use freelance journalists; or publish free content provided by the general public, or so called “vanity” articles providing opinion content.

Another way media outlets have adapted to these changing conditions is to use digital editions as a replacement for printed versions. However, such electronic editions typically only work in a paid-for subscription type model with very high readership/viewership, which often demand high quality content. Accordingly, media outlets face challenges in trying to meet consumers' demands to have high quality content at little or no cost.

It is an object of the following to address at least one of these disadvantages.

### SUMMARY

A system and method are provided for connecting producers of digital content (e.g. text, images, video, sound, etc.) with publishers of same for the completion of a commercial transaction. In at least one aspect, the system may also connect the producers of content in physical form (e.g., paper, video/audio tape or disc, photograph, etc.) with such publishers for the completion of a commercial transaction.

In one aspect, there is provided a method of enabling the publication of media content, the method comprising: enabling a producer of media content to post at least one media item to an online platform; providing access to the at least one media item via the online platform to at least one publisher registered with the online platform; receiving a request from a publisher to obtain rights to a particular media item posted by the producer; and enabling the publisher and the producer to perform a transaction transferring the rights to the particular media item from the producer to the publisher using the online platform.

In another aspect, there is provided a computer readable storage medium comprising computer executable instructions for performing the method.

In yet another aspect, there is provided a system comprising at least one processor, memory, and at least one communication interface, the memory comprising computer executable instructions for causing the processor to perform the method.

### BRIEF DESCRIPTION OF THE DRAWINGS

Embodiments will now be described by way of example only with reference to the appended drawings wherein:

FIG. 1 is a schematic diagram of a media brokering system;

FIG. 2 is a block diagram of an example of a configuration for a content producer device;

FIG. 3 is a block diagram of an example of a configuration for a content purchaser device;

FIG. 4 is a block diagram of an example of a configuration for a media brokering platform;

FIG. 5 is an example of a set of computer executable instructions that may be executed in enabling a buyer and a seller to interact with a media brokering platform;

FIG. 6 is an example of a set of computer executable instructions that may be executed in registering sellers and buyers of media content;

FIG. 7 is an example of a set of computer executable instructions that may be executed in enabling content to be submitted to the media brokering platform;

FIG. 8A is an example of a set of computer executable instructions that may be executed in enabling a buyer search to be conducted;

FIG. 8B is an example of a set of computer executable instructions that may be executed in enabling a content search to be conducted;

FIG. 9 is an example of a set of computer executable instructions that may be executed in initiating and conducting a live auction of media content;

FIG. 10 is an example of a set of computer executable instructions that may be executed in enabling a purchase of media content to occur;

FIG. 11 is a flow chart illustrating a content producer entry into a public portal for the media brokering system;

FIG. 12 is a flow chart illustrating a content publisher entry into a public portal for the media brokering system;

FIG. 13 is a flow chart illustrating dashboard navigation options for a content producer;

FIG. 14 is a flow chart illustrating dashboard navigation options for a content producer;

FIG. 15 is a flow chart illustrating options for offering content for sale;

FIG. 16 is a flow chart illustrating options for searching for content to buy;

FIG. 17 is a flow chart illustrating transaction operations for a content producer selling content;

FIG. 18 is a flow chart illustrating transaction operations for a content publisher buying content;

FIG. 19 is a flow chart illustrating transaction finalization operations for a content producer;

FIG. 20 is a flow chart illustrating transaction finalization operations for a content publisher;

FIG. 21 is a flow chart illustrating sale options for a content producer;

FIG. 22 is a flow chart illustrating operations for generating a request for production (RFP) of media content;

FIG. 23 is a flow chart illustrating access to databases accessible to content producers via a producer portal;

FIG. 24 is a flow chart illustrating access to databases accessible to content publishers via a publisher portal;

FIG. 25 is a flow chart illustrating an example of an end-to-end user interface workflow for interacting with a media brokering platform;

FIG. 26 is a screen shot of an example user interface for a main web page provided by a media brokering platform;

FIG. 27 is a screen shot of an example user interface illustrating options for producers (contributors) of media content;

FIG. 28 is a screen shot of an example user interface for providing instructions on submitting media content in a physical form;

FIG. 29 is a screen shot of an example user interface for enabling a producer of media content to register with the media brokering system;

FIG. 30 is a screen shot of an example user interface for enabling a producer of content to submit new content for sale;

FIG. 31 is a screen shot of an example user interface for enabling a producer to search for buyers;

FIG. 32 is a screen shot of an example user interface for enabling a producer of content to search for requests for proposals (RFPs) generated by publishers of media content;

FIG. 33 is a screen shot of an example user interface for enabling a producer to submit video-based media content;

FIG. 34 is a screen shot of an example user interface for enabling a publisher to complete an agreement with the media brokering system;

FIG. 35 is a screen shot of an example user interface for enabling access to a live auction hosted by the media brokering platform;

FIG. 36 is a screen shot of an example user interface illustrating options for a publisher of media content;

FIG. 37 is a screen shot of an example user interface for enabling a publisher to view video news;

FIG. 38 is a screen shot of an example user interface for enabling a publisher to view text-based news;

FIG. 39 is a screen shot of an example user interface for enabling a publisher to view photo-based news; and

FIG. 40 is a screen shot of an example user interface for enabling a search to be conducted of a content repository in the media brokering system.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It has been recognized that there does not currently exist, a viable technical solution in a digital marketplace for media content (e.g., text, images, video, and audio) that allows publishers of this content to reduce their costs while providing adequate remuneration for producers of such media content. The following system provides such a technical solution by having a platform acting as broker between potential sellers of content (i.e. the content producers) and the potential buyers of this content (i.e. the content publishers). The media brokering system described herein facilitates the submission of media content through a centralized platform creating a virtual marketplace for selling media content, for example, through direct sales, auctions, or syndication to allow publishers to legally obtain publishing rights in a trusted manner. The media platform also facilitates communications, exchanges of information between parties, and discussions between these parties, and allows for other mechanisms such as requests for proposals (RFPs) for particular media content that publishers are seeking. Upon matching produced content with a potential publisher, the media brokering platform also facilitates financial transactions of the media content, along with the underlying copyright associated with the media content.

In this way, a free marketplace can be provided for the exchange of journalistic and other media content for remuneration that allows negotiation and communications between the sellers and the buyers to seek a more accurate market value for particular content. As discussed in greater detail below, the system described herein also provides a controllable platform that enables performance measures and controls to be applied with respect to the content, e.g. to detect and thwart plagiarism and/or illicit re-publication of content.

In addition to facilitating direct interactions and transactions, the repository of content held by the media brokering platform enables publishers to browse available content, enter live auctions or promotional processes, and post desired content or topics to stimulate the creation of particular media content by willing producers.

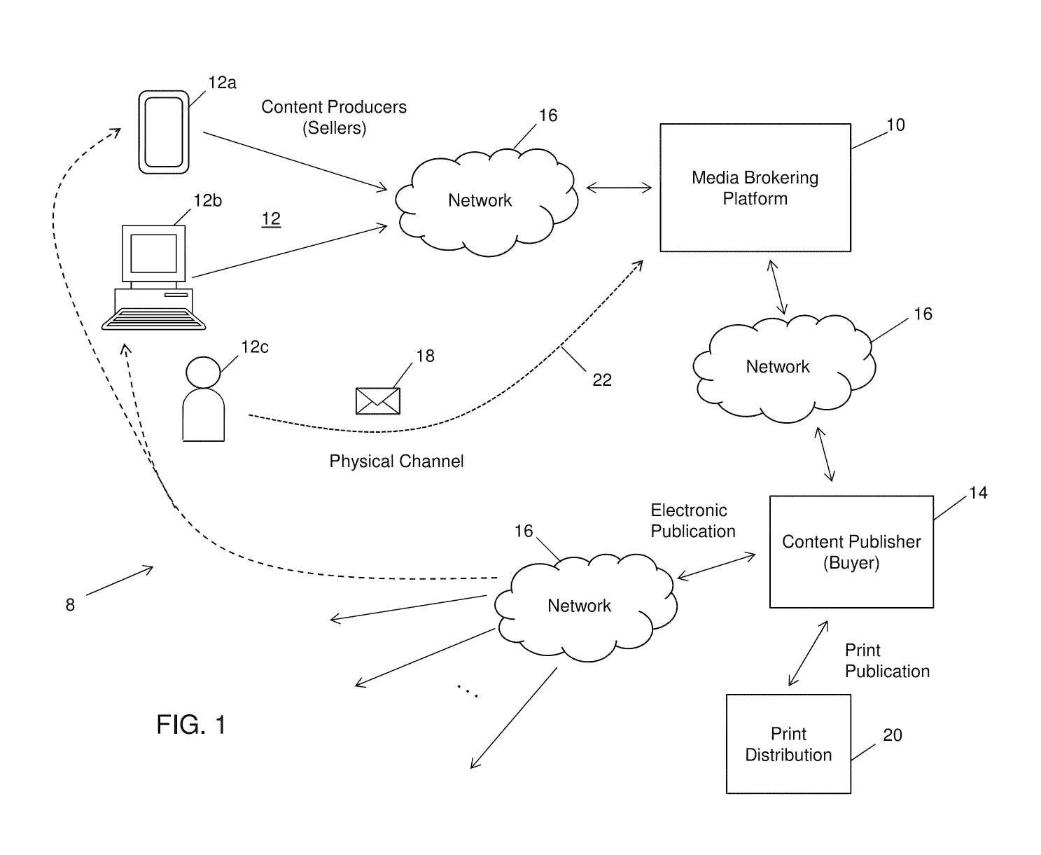

Turning now to the figures, FIG. 1 illustrates an example of a configuration for a media brokering system 8 which provides a media brokering platform 10 (the “platform 10” hereinafter) accessible and communicable with content producers 12 (i.e. “sellers” of media content) and content publishers 14 (i.e. the “buyers” of media content). The content producers 12 and content publishers 14 may communicate with the platform 10 via one or more networks 16, such as the Internet, cellular networks, data-over-power, etc. As illustrated in FIG. 1 by way of example, the content producers 12 may also communicate with the platform 10 using a physical channel 22 such as a postal or courier service in order to deliver a physical medium 18 comprising the particular content to be processed and incorporated into the system 8 by the platform 10.

As indicated above, such media content may include text, images, video, and audio, any of which may include particular types of media, such as news content. Although the following examples relate illustratively to examples in which the sale of news content is being brokered, it will be appreciated that the principles described herein can be applied to any type of media content, for example, technical or legal literature or video/image content, etc.

Various types of devices facilitating the provision of media content by content producers 12 to the platform 10 are shown in FIG. 1, including a smartphone, tablet computer or other handheld or “mobile” device 12a and a desktop computer 12b. It can be appreciated that any electronic device capable of sending digital content via a network 16 to the platform 10 may be used. A user 12c is also shown in FIG. 1 to illustrate the provision of a physical medium 18 via the physical channel 22.

The content publisher 14 also communicates and interfaces with the platform 10 via one or more networks 16 and upon obtaining desired media content (typically in electronic form), the content publisher 14 can utilize the desired media content in both electronic publications (e.g., via digital news editions, television, radio, social media, weblogs, etc.), and print publications (e.g. newspapers, magazines, circulars, etc.). As such, for electronic publications, the content publisher 14 may re-engage the one or more networks 14 in order to electronically distribute the media content, which may include delivery of the content to the same types of devices 12a, 12b utilized to submit the content in the first place (see dashed lines in FIG. 1). The print publications may utilize traditional forms of print distribution 20 with the content being sourced using the platform 10 rather than staff or freelance talent.

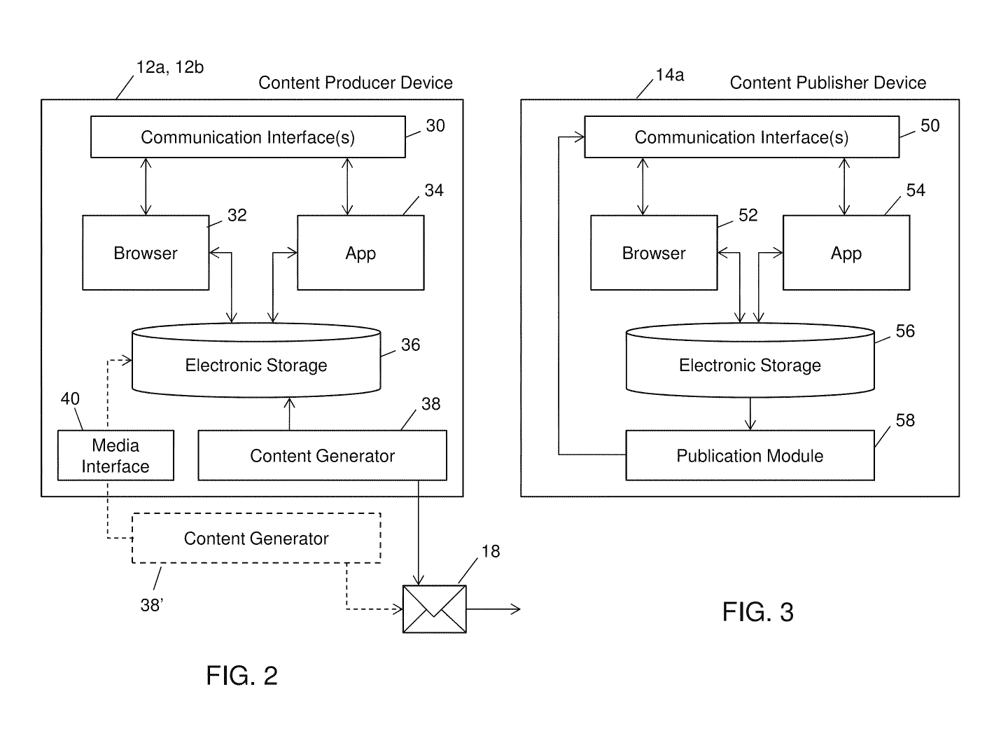

An example of a content producer device 12a, 12b is shown in FIG. 2. The device 12a, 12b includes at least one communication interface 30 for accessing the one or more networks 14. In order to access a user interface and portal provided by the platform 10, the content producer device 12a, 12b may include a browser 32 or application (e.g. custom “app” 34 as shown in FIG. 2). The content producer device 12a, 12b also includes an electronic storage 36 or other memory element to at least temporarily store media content generated by a content generator 38. As shown in FIG. 2, the content generator 38 can reside on the device 12a, 12b (e.g. Word processor, camera, microphone, etc.).

Alternatively, media content may be generated by an external content generator 38′, which can upload digital content to the device 12a, 12b via a media interface 40 (e.g. via a media card or network connection) or may generate physical media 18 which is sent using a physical channel 22.

It can be appreciated that media interface 40 may be provided by one or more of the communication interfaces 30 and the configuration shown in FIG. 2 is illustrative only. Moreover, since the media content may be generated outside of the device 12a, 12b and sent via a physical channel 22, the content producer 12 may not require a device 12, 12b in order to provide the media content. However, as illustrated below, the content producer 12 advantageously interfaces with the platform 10 at least to determine how to provide physical media 18 and/or to register and communicate regarding such physical media 18.

FIG. 3 illustrates an example of a content publisher device 14a, which may also comprise a mobile or desktop computer. Similar to the content producer device 12a, 12b, the content publisher device 14a includes at least one communication interface 50 to interact with the platform 10 over the one or more networks 14, a browser 52 and/or app 54 to provide a user interface, and electronic storage 56 or other memory element to at least temporarily store acquired media content. In this example, the content publisher device 14a also includes a publication module 58 which may represent any application, interface, or program instructions that enable media content acquired from the platform 10 to be provided to an appropriate content publication channel (electronic, print, etc.). It can be appreciated that the publication module 58 may utilize the at least one communication interface 50 to send the media content to a publication mechanism electronically.

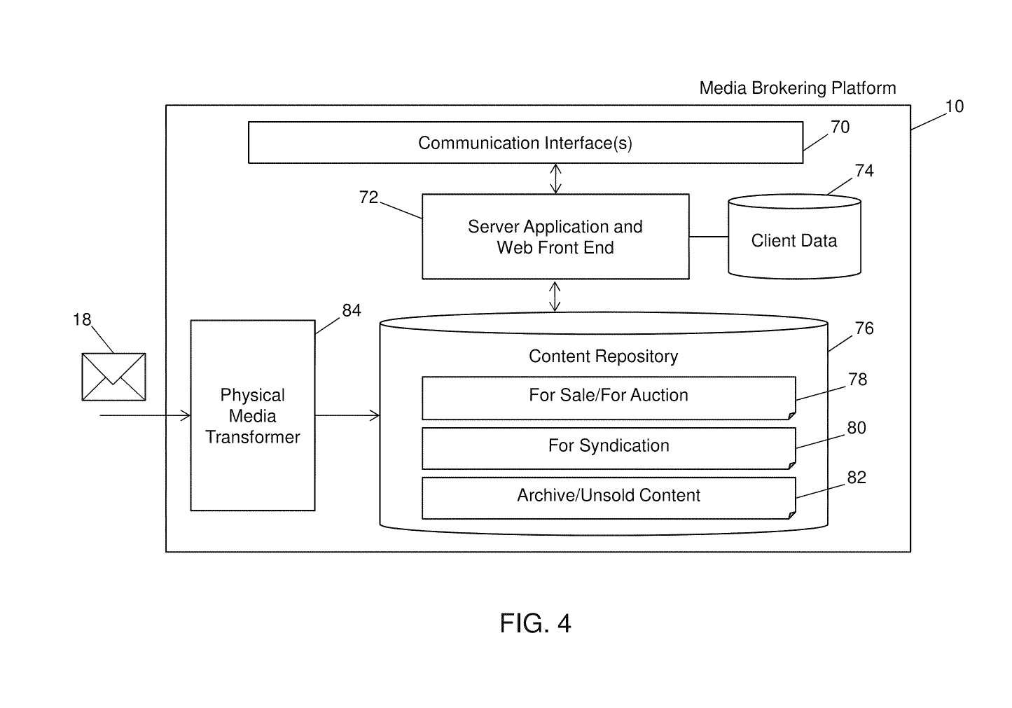

An example of a configuration for the platform 10 is shown in FIG. 4. Similar to the devices shown in FIGS. 2 and 3, the platform 10 also includes at least one communication interface 70 to enable the platform 10 to interact with the content producers 12 and content publishers 14 via the one or more networks 14. The platform 10 also includes a server application and web front end 72 (the “server application 72” hereinafter) to provide the virtual marketplace and facilitate communications and transactions between the content producers 12 and content publishers 14. As discussed in greater detail below, such communications can be initiated by the producers 12/publishers 14 or by the platform 10, e.g. to react to breaking news uploaded by a producer 12. As will be illustrated in greater detail below, the server application 72 provides a web page and various user interfaces for interacting with the platform 10 and to initiate communications and transactions with other participants. The server application 72 may include or otherwise have access to client data 74, which may store registration and profile information for registered users, for example, users associated with the content producers 12 and content publishers 14.

The platform 10 in this example includes or otherwise has access to a content repository 76, which stores media content. It can be appreciated that the content repository 76 may utilize any suitable data structure such as a database, media memory, etc. The content repository 76 may be located at least in part in a location remote to the platform 10, e.g. in the “cloud”. Moreover, the content repository 76 may be structured to maintain lists of available content in the platform 10 with the actual content stored elsewhere. As such, it can be appreciated that the configuration shown in FIG. 4 is illustrative only.

In the example shown in FIG. 4, the content repository 76 stores media content that is for sale or for auction 78, stores media content that is for syndication 80, and may store unsold or archived content 82. It can be appreciated that the platform 10 can be adapted or replicated for any number of subjects and purposes, for example, topics may include news, “oped”s, travel, food, etc. Moreover, content may be used for company annual reports, advertorials, public relations, technical journals, etc. Such content may be similarly integrated into the platform 10 or a version thereof using RFPs. With respect to RFPs, it can be appreciated that the server application 72 can be configured to support an RFP or “commissioning” engine or module accessible to the publishers 14 to enable publisher-subscribers to put projects up for bid. For example, a publisher 14 could post a request such as “Editor X needs 2000 word feature on holiday cake recipes with photos for print and online” in a particular region. In another example, a news outlet or publication could post: “Need G20 main-in-the-street coverage and photos/video/etc. for broadcast within North America”. Therefore, the platform 10 can provide a convenient mechanism for editors to set forth the content they wish to acquire for a particular issue, episode, program, documentary, etc. and have access to registered users and the associated talent and access to the content they desire.

To enable physical content 18 to be incorporated into the system 8, the platform 10 may also include or otherwise have access to a physical media transformer 84, which represents any application, tool, or machine that enables a physical medium 18 to be converted into an electronic format suitable for storage in the content repository 76. For example, the physical media transformer 84 may include a digital scanner, media interface, word processor, microphone, etc.

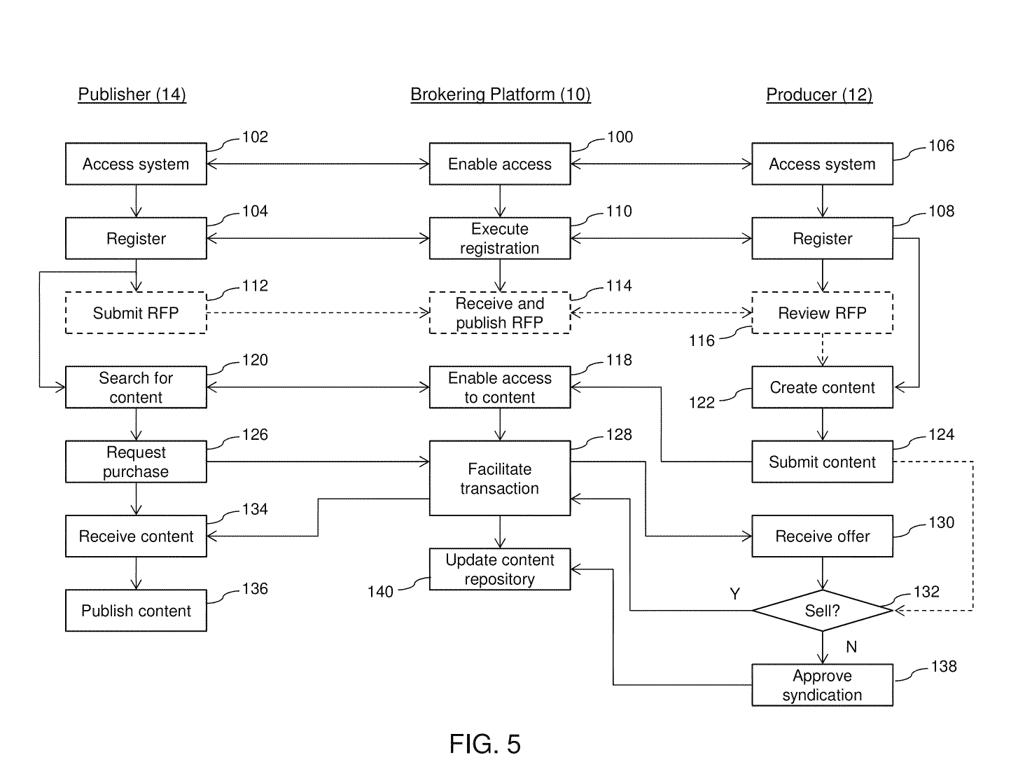

Turning now to FIG. 5 example interactions between the platform 10, a content producer 12, and a content publisher 14 are shown to illustrate the provision and acquisition of media content brokered by the platform 10. At 100 the platform 10 enables access to the system 8, e.g., by providing a web page or other “front end” via a server application 72. This enables the publisher 14 to access the system 8 at 102 and register at 104, and the producer 12 to access the system 8 at 106 and register at 108. The platform 10 therefore executes and enables the registration process to occur at 110. It can be appreciated that the registration operations would only be required for new users and that in subsequent visits, the publishers 14 and producers 12 would participate in a login or other authentication process instead (not shown in FIG. 5 for ease of illustration).

Registered users may then engage each other and otherwise interact with the system 8 via the platform 10. For example, as shown in FIG. 5, a publisher 14 may submit an RFP at 112 to have particular content generated. The platform 10 receives and publishes the RFP at 114 and this allows a producer 12 to review the RFP at 116, which may contribute to creating specific content at 122 which is submitted at 124. It can be appreciate that, as illustrated using dashed lines in FIG. 5, the RFP process is optional and may only be used for some particular media content. As described below, other media content may be asynchronously uploaded and found via the platform 10.

At 118 the platform 10 enables access to content in its content repository 76, for example, by providing a search function through a web page which has access to at least a listing of available content and may include additional metadata to facilitate the search. In the example shown in FIG. 5, the publisher 14 searches for content at 120, in this case, which has been previously submitted by the producer 12 at 124. A request for purchase may be made by the publisher 14 at 126, which initiates the facilitation of a transaction by the platform 10 at 128. For example, the request at 126 may be received via an auction bid or a direct request to buy the content at a set price. During the transaction, an offer for the content is provided to the producer 12, which is received at 130. For example, a request to purchase the content may be sent via an email, text message, instant message, social media communication, application update, voicemail or other communication method.

At 132 the producer 12 has determined based on the offer whether or not to sell the content. If so, the transaction proceeds and finalizes with the publisher 14 receiving the content at 134. The publisher 14 at this point owns at least some rights to publish the content at 136. If the producer 12 does not sell the content at 132, for example if the offer is refused, or an offer is not received (e.g. a failed auction or timeout for the sale), the producer 12 in this example may approve syndication of the content at 138, which allows multiple publishers 14 to republish the content on a non-exclusive basis at a reduced cost. It can be appreciated that the content may also be initially offered for syndication at a fixed price. Also, a publisher 14 or other buyer of content may also be given the option or ability to syndicate content that was purchased on an exclusive basis. Moreover, publishers 14 may also register with the platform 10 as sellers of content, e.g. to unload content from a library of acquired content, e.g. to allow syndication of that content.

Following any transaction or syndication of the media content, the platform 10 updates the content repository 76 at 140. For example, purchased media content may be removed post-sale or its status changed to “syndicated” if syndication is approved at 138.

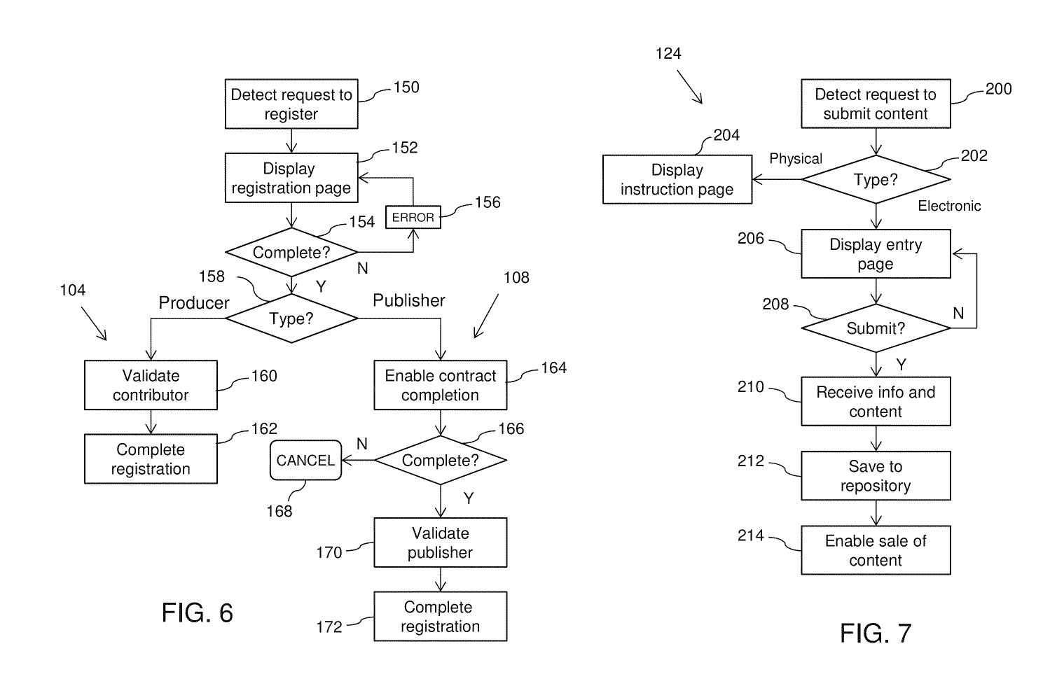

Further detail regarding the registration processes 104 and 108 is illustrated in FIG. 6. The platform 10 (e.g. via the server application 72) detects a request to register at 150. For ease of illustration it will be appreciated that the request may be made by either a producer 12 or a publisher 14, e.g. by selecting a link or tab in on a web page. The platform 10 displays at registration page at 152 and determines at 154 whether or not the registration fields (e.g. the mandatory fields) have been completed. If not, an error or other message may be provided at 156. Once the registration fields have been completed if the registrant is a producer 12, the platform 10 validates the contributor at 160 (e.g. by ensuring a duplicate registration does not exist, etc.), and completes the registration at 162, e.g. by creating a new user in the client data 74.

If the registrant is a publisher 14, the platform 10 enables a contract to be completed at 164. The contract is provided in order to have the publisher 14 agree to certain terms for publication, e.g., exclusivity, ownership, etc. An example of such a contract is provided below. The platform 10 determines at 166 whether the contract has been completed. If not, the registration process is cancelled at 168. For example, the registrant may cancel the process or not properly complete the contract. If the contract is completed, the registrant is validated by the platform 10 at 170 and the registration for that publisher 14 completed at 172. Publisher registration may also be subject to (a) a review to ensure that registrant meets predetermined criteria for being a publisher 14, (b) approval by an administrator of the platform 10 once these criteria have been reviewed and the contract completed and confirmed, and (c) a probationary period (e.g. 90 days) during which any violation of particular criteria (e.g. terms of agreement) can cause cancellation or suspension of an account.

It can be appreciated that the registration processes 104 and 108 are shown together in FIG. 6 for ease of illustration and these processes may be implemented separately. For example, the request detected at 150 may inherently determine whether or not the registrant is a prospective producer 12 or a publisher 14 by virtue of which link or on which web page the request is initiated.

FIG. 7 illustrates an example of a set of operations that may be executed by the platform 10 in enabling media content to be submitted to the system 8. At 200 the platform 10 detects a request to submit content and determines a type of request at 202. If it is determined that the user is requesting to submit physical content, the platform 10 displays an instruction page at 204 to enable the producer 12 to determine how to submit using a physical channel 22. If it is determined that the user is requesting to submit electronic content, e.g., directly through the server application 72, the platform 10 displays an entry page at 206 to allow information associated with the media content, and even the content itself to be entered. For example, a text-based news article may be submitted by copying the text directly into the web page. The content may also be uploaded using a corresponding option. For example, an option to “Upload Video” or “Upload Article” may be presented and selected by the user. The platform 10 determines at 208 whether or not the content has been submitted (e.g. by determining when a “Submit” button has been selected). Once submitted, the platform 10 receives the content and any information or metadata provided with the content at 210 and saves the new content to the content repository 78 at 212. Once the content is saved in the system 8, the platform 10 may enable the sale of this content at 214, e.g., by scheduling an auction, posting the content for sale, etc.

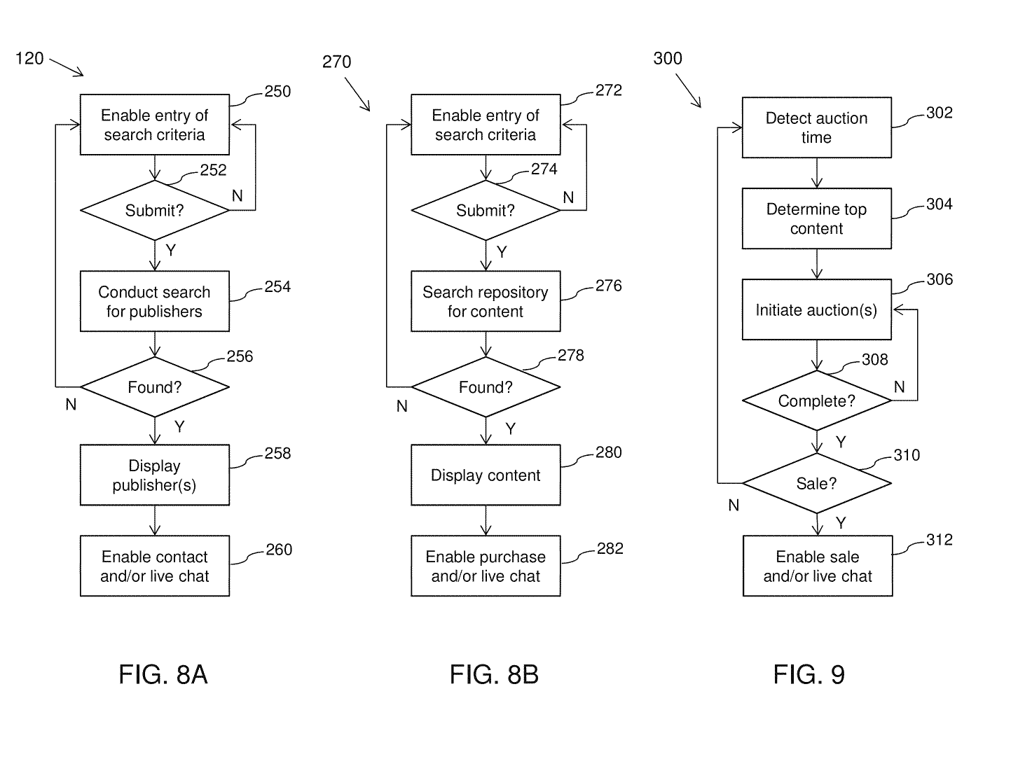

FIGS. 8A and 8B illustrate processes 120, 270, that may be executed into enabling potential buyers and content to be searched respectively. As shown in FIG. 8A, at 250 the platform 10 enables the entry of search criteria and determines whether a query has been submitted at 252. If so, a search for potential buyers is conducted at 254 according to the search criteria, for example, registered publishers 14 in a particular geographical location, publishers 14 requesting certain types of content (whether specific RFPs or otherwise), etc. The platform 10 determines at 256 whether or not the search has returned any positive results. If so, the potential publishers 14 are displayed at 258 for the content producer 12 conducting the search. The platform 10 may also enable contact to be made with particular publishers 14 and/or a live chat to be initiated at 260, e.g. to allow the content producer 12 to propose particular media content or to propose ongoing arrangements to buy particular content.

As shown in FIG. 8B, the platform 10 may similarly enable entry of search criteria at 272 for searching content in the content repository 78. After determining at 274 that search criteria have been entered, the platform 10 conducts a content search at 276. If content is found at 278 according to the search criteria, the search results, e.g. a list of content is displayed at 280. The platform 10 may at this point enable a direct purchase or participation in a current auction at 282, and/or enable the publisher 14 to initiate a communication such as a live chat at 282.

It has been recognized that in order to promote new and/or particularly interesting or “in demand” media content, the platform 10 provides an advantageous venue to facilitate auctions for the media content. In addition to regular auctions that can be initiated by the content producer 12, it has been found that the platform 10 may also schedule live auctions for such in demand content. An example of a live auction process 300 is shown in FIG. 9. The platform 10 may be controlled by one or more administrators that determine “top content” and schedule live auctions, e.g. live daily auctions. At 302 the platform 10 detects a starting time for the live auction and determines the top content for the auction at 304. The auction may include several “lots” in one auction session or may initiate several concurrent auctions at that time. The one or more auctions are then initiated at 306 and continue until it is determined by the platform 10 at 308 that the auction(s) is/are completed. For example, each live auction may occur for a predetermined amount of time and/or may include a “buy now” option which would immediately end the auction. Once the live auction is completed, the platform 10 determines if there has been a purchase made at 310. If not, the auction process repeats at the next scheduled time. If a purchase was made, the sale of the content is enabled at 312, which may include the initiation of a communication such as a live chat between the content producer 12 and the content publisher 14 at 312.

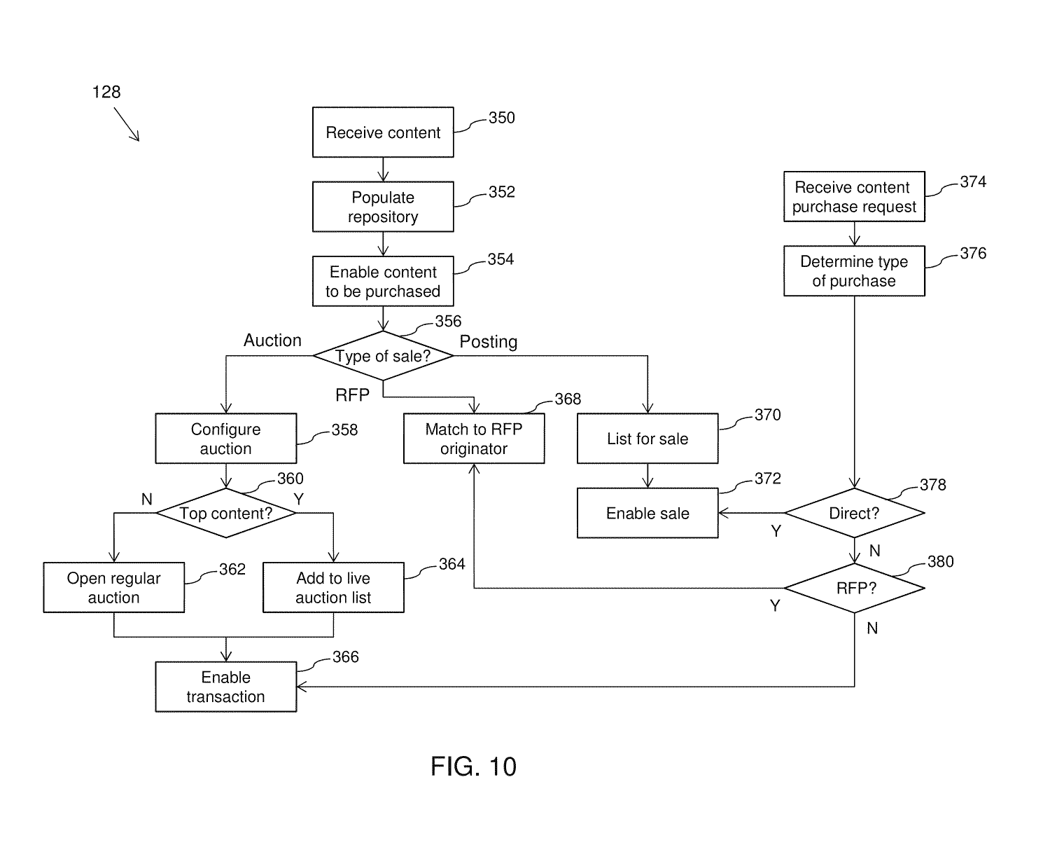

Turning now to FIG. 10, further detail for implementing the facilitation of a transaction e.g., at 128 in FIG. 5, is shown. At 350, the platform 10 receives content, populates the repository 78 with that content at 352, and enables the content to be purchased at 354, as discussed above. The platform 10 determines that type of sale associated with the content, which may be according to the type of content, options selected by the content producer 12, or other criteria. For an auction sale, the platform 10 configures the auction at 358, e.g., to set reserve prices, timelines, etc. The platform 10 may also determine at 360 whether or not the content is considered “top content”. If not, a regular auction is opened or otherwise initiated at 362. On the other hand, if the content is determined to be top content, this content is added to a live auction list at 364. The platform 10 also enables a post-auction sale or other transaction at 366.

When the type of sale is to meet the demands of an RFP, the platform 10 matches the content to the RFP originator at 368. When the type of sale is a regular direct purchase or “listing”, the platform 10 lists the content for sale at 370, and enables the sale at 372.

The above-described operations shown in FIG. 10 are facilitating the seller's side of the transaction. On the other side of the transaction, the platform 10 receives a content purchase request at 374 and determines the type of purchase at 376. If the platform 10 determines at 378 that the purchase is direct, the direct purchase is enabled in conjunction with 372. If not, the platform 10 determines at 380 whether or not the transaction is related to an RFP. If so, the publisher 14 is associated with the original RFP and is matched with the content producer 12 at 368. In this example, the transaction is otherwise associated with an auction and the transaction post-auction is enabled at 366 as described above.

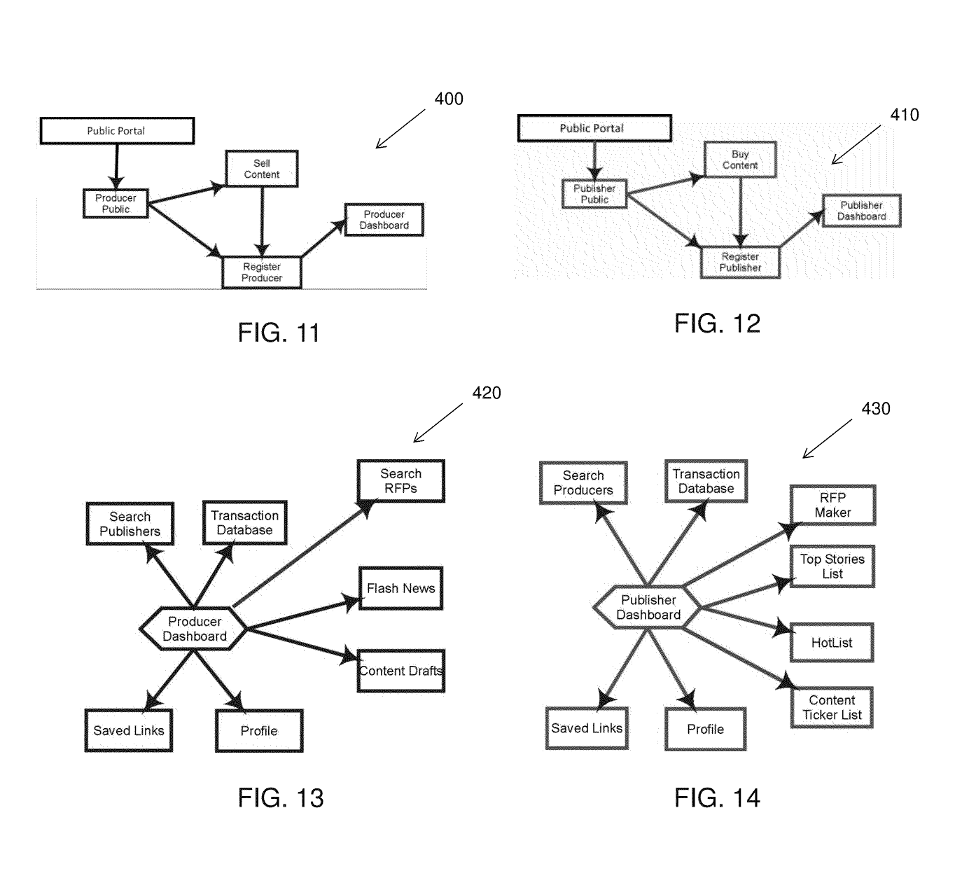

FIGS. 11 to 25 illustrate various exemplary navigational flow charts illustrating user interactions with the platform 10, from both the content producer's and the content publisher's perspective. Turning first to FIGS. 11 and 12, registration flows 400 and 410 are shown for the producer 12 and publisher 14 respectively. In FIGS. 11 and 12, it can be seen that a public portal can be accessed by any potential producer 12 or publisher 14 with the ability to register either upon request, or upon trying to buy or sell content. For example, the platform 10 can freeze all links except the registration link, or have any clickable link automatically request registration. Once registered, the producer 12 or publisher 14 may be navigated to a dashboard, which can be customized and/or personalized by respective users. For registered users, it can be appreciated that such users may also be able to login to the public portal through the same webpage. It can also be appreciated that post-registration, users may download a custom client application to avoid the need to login in on subsequent visits.

During the registration process, the platform 10 may require mandatory information to be entered, e.g. to ensure that potential publishers 14 and producers 12 can be validated. For example, publishers 14 may require a validation process to confirm the identity and legitimacy of the underlying business associated with the publisher 14 and/or to determine a credit rating or any other suitable validation metric. For both producers 12 and publishers 14, a “Terms of Use” for the platform 10 can also be imposed during the registration process. As will be illustrated in greater detail below, the terms of use and any other contractual arrangement with the platform 10 may be subjected to a clause-by-clause acceptance procedure. The registration process may also impose a probationary period for new users (e.g. producers 12) to use the system 8 with participation monitored by an administrator to ensure quality control and other standards to be met.

FIGS. 13 and 14 illustrate various options that may be provided through the producer dashboard 420 and the publisher dashboard 430 respectively. The dashboards may be provided as functional tools for the user to navigate through appropriate regions of the platform 10.

As shown in the example of FIG. 13, the producer's dashboard may include the following options:

(1) Scrolled link lists to saved personal content, for example: a. database of content submitted for sale, and/or draft content in progress which will be uploaded at a later time; b. transaction database that includes records of all transactions; and

(2) Other links such as: a. complete/edit profile; b. search: RFPs and publishers 14; c. saved links (e.g. searches) which may include an RSS feed of RFP offerings based upon fields within the producer's profile; d. mobile upload which allows content to be posted from a mobile phone or other portable device such as a camera or embedded computing device, etc.

A utilities option can also be provided to include a text or instant messenger and “live chat” which can be established with a relevant publisher during or subsequent to a transaction.

As shown in FIG. 14, the publisher's dashboard may include the following options:

(1) A “Hot List” containing a comprehensive RSS of links to titles of content added to the website since the publisher's last visit (e.g., sorted in declining order according to the number of times the content summary was previewed by publishers);

(2) “Top Stories” where site administrators identify content submissions considered to be of high quality, which may be placed in boxes “above the fold” and contain a synopsis, a picture or thumbnail (if relevant) of the producer and the syndicated sale price or current auction amount;

(3) “Content Ticker” which comprises a “scrolling” RSS or other feed with items posted in real time as offered for sale with each link having the following information: a. a synopsis, b. a link to the producer's profile, and c. the current “auction” or “syndication” price. These links, when clicked, may navigate directly to a “Content Item Profile” which will allow an auction bid to be made or Syndicated Content rights to be acquired. Content Profiles can be imbedded in a protected graphic file that cannot be copied, downloaded or printed; and

(4) Other links which may include without limitation: a. complete/edit corporate and personal profile, b. “Saved Links” database of searches and RSS feeds based upon a publisher's “Interest List Profile”, c. “Purchased Content”, which includes a database of content acquired by the publisher 14, d. a database of RFPs issued and in progress, e. transaction records, and f. an option to search for producers 12.

Similar to that for producers 12, the publisher's dashboard may also include a utilities option that includes a text or instant messenger and “live chat” which can be established with a relevant publisher during or subsequent to a transaction.

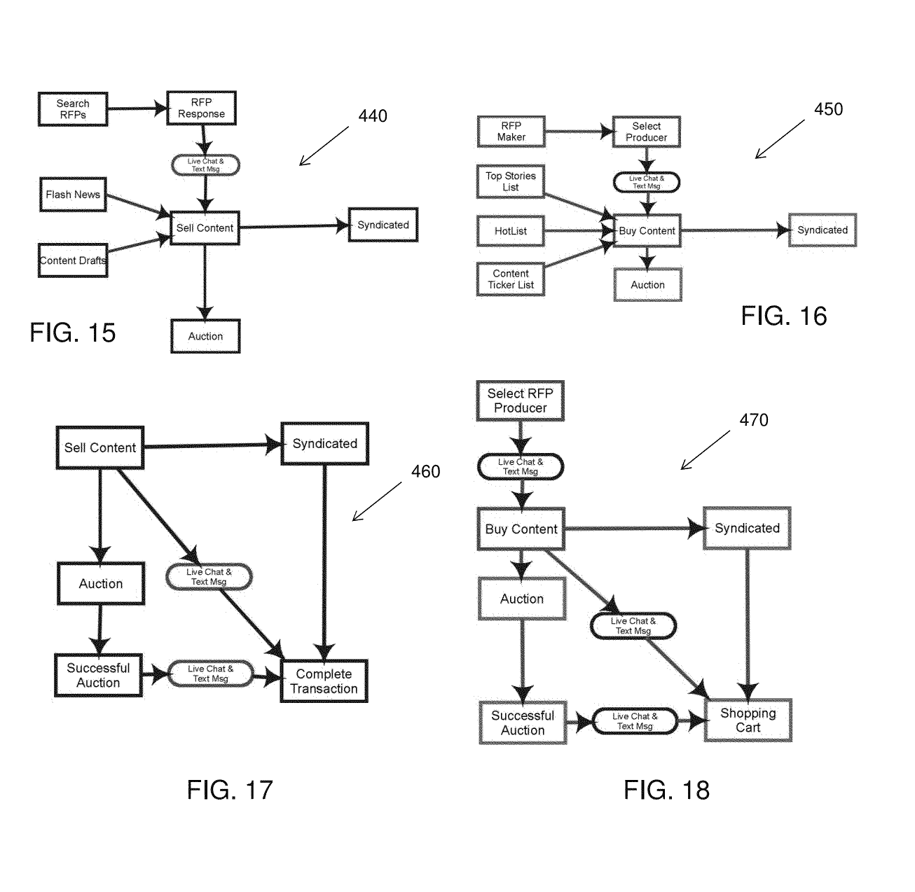

FIGS. 15 and 16 illustrate exemplary workflows leading to the submission of content for sale by a producer 12, and the purchase of content by a publisher 14.

As shown in FIG. 15, producers 12 may use the platform 10 to sell content by either responding to RFPs or offering or posting content through the platform 10 for sale. In the example shown in FIG. 15, after searching for RFPs, and RFP response can be submitted through portal 10 and may include a direct communication with the originator of the RFP, e.g. by way of a live chat (voice, instant messaging, video, etc.) or one-way communication such as a text message or email. When offering content for sale (e.g. flash news, content drafts, etc. as shown in FIG. 15), a producer 12 can establish pricing and terms of the sale by offering a fixed price available to any publisher 14 who is interested in acquiring rights to the content (as well as the number of publishers 14 that may purchase, i.e. the exclusivity of the content), or by offering content for auction. When setting terms for an auction, various options may be provided to the producers 12, including the ability to set a reserve price, opening bid, a number of publishers 14 who are permitted to purchase rights (i.e. if the content is being sold on a non-exclusive basis), and the time limits associated with the auction itself. As indicated above, live auctions may also be held by the platform 10, in which case, the producer 12 may be given an option to opt in or opt out of participating live in auctions for “top content”. As discussed above, the platform 10 may utilize an anti-plagiarism tool or module to review content offered for sale (and sample content provided during registration) to track plagiarism of legitimate content by third parties subsequent to publication. For example, keywords or phrases may be extracted from the content and a web search conducted to determine if all or portions of the content can be found. Similarly, image processing can be used to determine if similar images or videos can be found online. Any other data available to the platform 10 could also be used, for example, metadata, administrator-supplied criteria, etc.

FIG. 16 illustrates various ways for publishers 14 to purchase or otherwise acquire content through the platform 10. The publisher 14 can dictate the type of content it is interested in by generating an RFP to allow producers 12 to apply to complete the content “on demand”. The RFP process is managed by the portal 10 to provide the publishers 14 with access to registered and validated producers 12 and may provide ratings, rankings, past work, and recognitions concerning the potential producers 12 to allow the publishers 14 to select the most appropriate producer 12 to fulfill the RFP. Similar to what is shown in FIG. 15, the RFP process may also include the initiation of direct communications between producers 12 and publishers 14 participating in the RFP process.

The publishers 14 may also purchase content that is being offered for sale by producers 12, e.g., for participating in an auction for the content, or by pursuing a direct purchase. For example, content offered for sale can be acquired from various lists, such as: a “Top Stories” list, a “Hot List” which ranks content by the number of times they have been looked at, and the “Content Ticker” list which ranks content by time and date offered for sale with the newest at the top.

FIGS. 17 and 18 illustrate exemplary workflows for enabling transactions to take place, from the perspective of the producer 12 and publisher 14 respectively.

In FIG. 17, in parallel with selling content through an auction or syndication the producer 12 may engage in communications with potential purchasers, e.g. via chats, message exchanges, voice or video chats, etc. Moreover, after a successful auction, the winning publisher 14 can be put in touch with the producer using any one or more of these communication media. The platform 10 also facilitates the transaction once the sale is agreed upon. Publishers 14 may also be given a mechanism to report misuse of the communications tools provided by the platform 10.

FIG. 18 illustrates the transaction flow from the perspective of the publisher 14 interacting with the platform 10. Content may be purchased whether or not an RFP selection is utilized, and the publisher 14 may engage in an auction or direct purchase (e.g. of syndicated content), as well as direct communications with the producer 12 that are initiated through the platform 10. It can be appreciated that the platform 10 can therefore be configured to allow a transaction to be completed by allowing a producer 12 to approve a transaction price, for the publisher 14 to confirm the transaction, for the two counterparts to discuss/negotiate using various communication media (e.g. text messaging and/or live chat), and the publisher 12 to add the content being purchased to a “Shopping Cart” to allow multiple content purchases to be made during the same session on the platform 10.

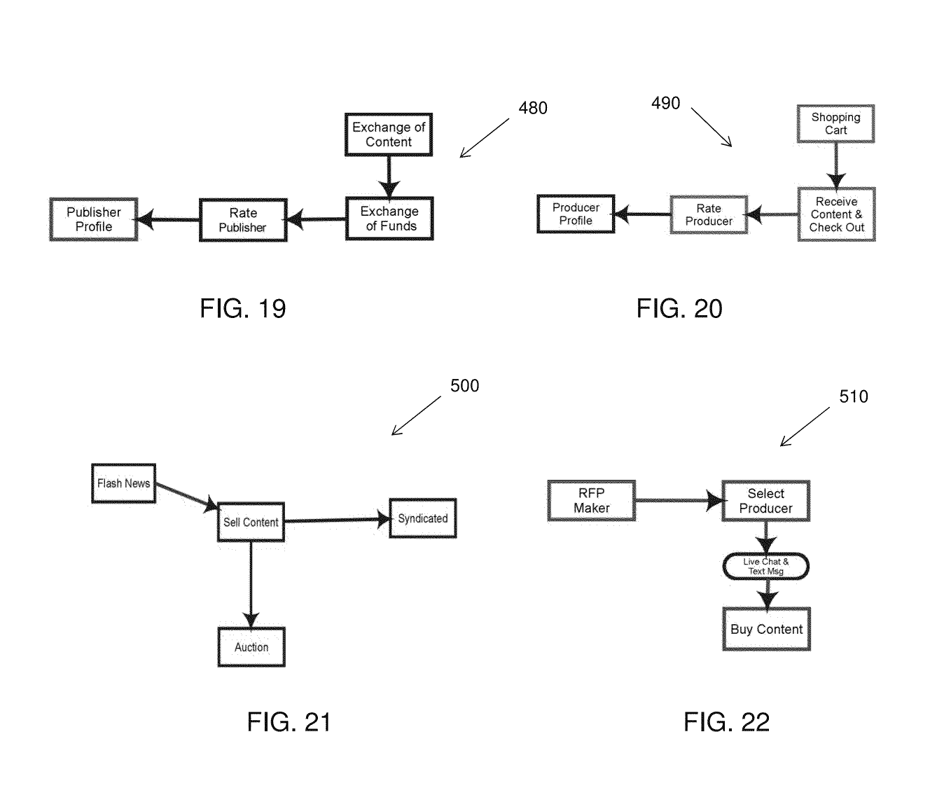

FIGS. 19 and 20 illustrate operations that may be facilitated by the platform 10 as a transaction is being finalized and/or post-transaction. When the exchange of payment has been completed, then the producers 12 and publishers 14 may be provided with options to rate each other in order to update profiles that can be used to promote users within the system 8 and provide confidence to those engaging the system regarding the quality of the parties involved in transactions. Moreover, these post-transaction operations can be used to report problems with particular users or with the system 8 itself.

FIGS. 21 and 22 illustrate convenient submissions of content for sale and RFPs respectively. The system 8 can be configured to provide customized apps or widgets to enable a user to capture media content and immediately upload such content to the platform 10, which is particularly advantageous for breaking news. By providing customized applications on the user-devices, the system 8 can minimize the number of steps required to get fresh content into the system 8. For example, an app or widget may have implicit login credentials to avoid the need to sign in each time the app or widget is used. Similarly, for publishers 14, a tool, app, widget or other application can also be provided for publisher-used-devices, e.g. to quickly and conveniently submit RFPs as particular requests become important.

It can be appreciated that such widgets, apps, or other applications may also be configured to deeply integrate any and all features described herein, for example, to allow a producer 12 or publisher 14 to conveniently access their dashboard and engage the platform 10. Similarly, mobile e-commerce functionality may be built in to not only facilitate submissions to the platform 10 but the transactions themselves. Such integration can be particularly important to facilitate transactions for breaking news, wherein producers 12 and publishers 14 are put into contact with each other to finalize a transaction substantially in real time, particularly by using live communication tools and network access. For example, the communication capabilities provided by the platform 10 allow for appropriately equipped citizens, freelance reports, among others, to react to breaking news and immediately alert potential buyers. For example, a fully equipped reporter/cameraperson with a satellite uplink (or other suitable communication link) that are onsite when breaking news occurs (e.g. tornado, volcano eruption, tsunami, war/conflict, traffic accidents, etc.) may use the communication interface 30 and any application or interface available on the device they have to upload the breaking news content (e.g. video, voice notes, text (if possible), etc.)—e.g. by satellite. The platform 10 may then be configured to handle breaking news in the server application 72 by communicating with subscribers such as registered publishers 14 to alert them of not only the breaking news but the immediately available content. From there a direct purchase, auction, or other transaction can be initiated, e.g. as herein discussed by way of example.

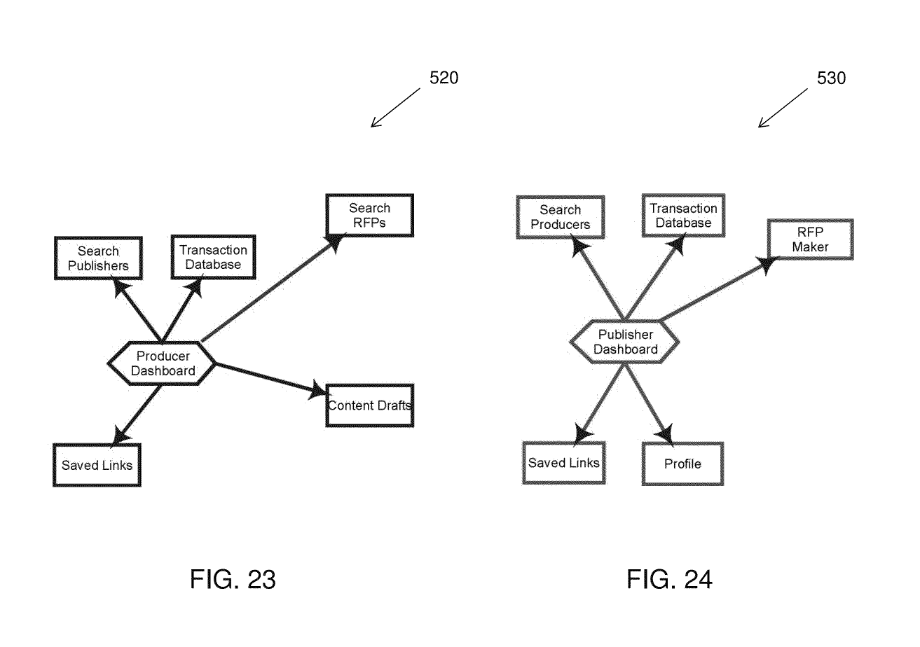

FIGS. 23 and 24 illustrate various databases that can be made available to producers 12 and publishers 14 respectively.

As shown in FIG. 23, producers 12 can be given access to various saved information such as: (1) Scrolled link lists to saved personal content including: a. database of content submitted for sale and draft content in progress which can be uploaded from a text editor, b. transaction Database: records of all transactions; (2) other links that may include: a. Complete/Edit Profile, b. Search: RFPs and Publishers, c. Saved links (searches) which may include an RSS Feed of RFP offerings based upon fields within the producer's profile, etc.

As shown in FIG. 24, for a publisher 14, databases of saved information may include: a. “Saved Links” Database of searches, b. RSS feeds based upon a publisher's “Interest List Profile”, c. “Purchased Content”, d. RFPs Issued and In Progress”, e. “Transaction Records”, and f. “Search Producers Results”.

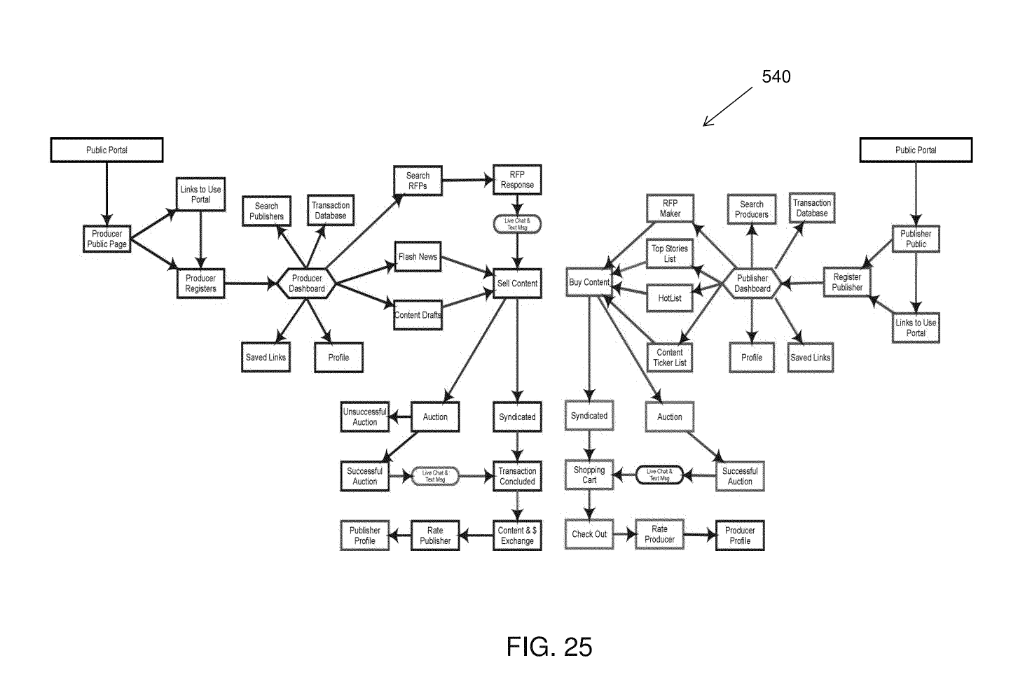

FIG. 25 illustrates an example user interface workflow that may be provided by the platform 10 based on at least some of the illustrations provided in FIGS. 11-24. It can be seen that the platform 10 is configured to allow a smooth flow from viewing/submitting to a transaction and communications between parties.

It can therefore be appreciated that a wide variety of arrangements of content and users are possible, with the advantage of providing publishers 14 with the ability to acquire rights to a potentially vast volume of content for publication, and for producer 12s to offer for sale an equally vast volume of text, image, video and audio content.

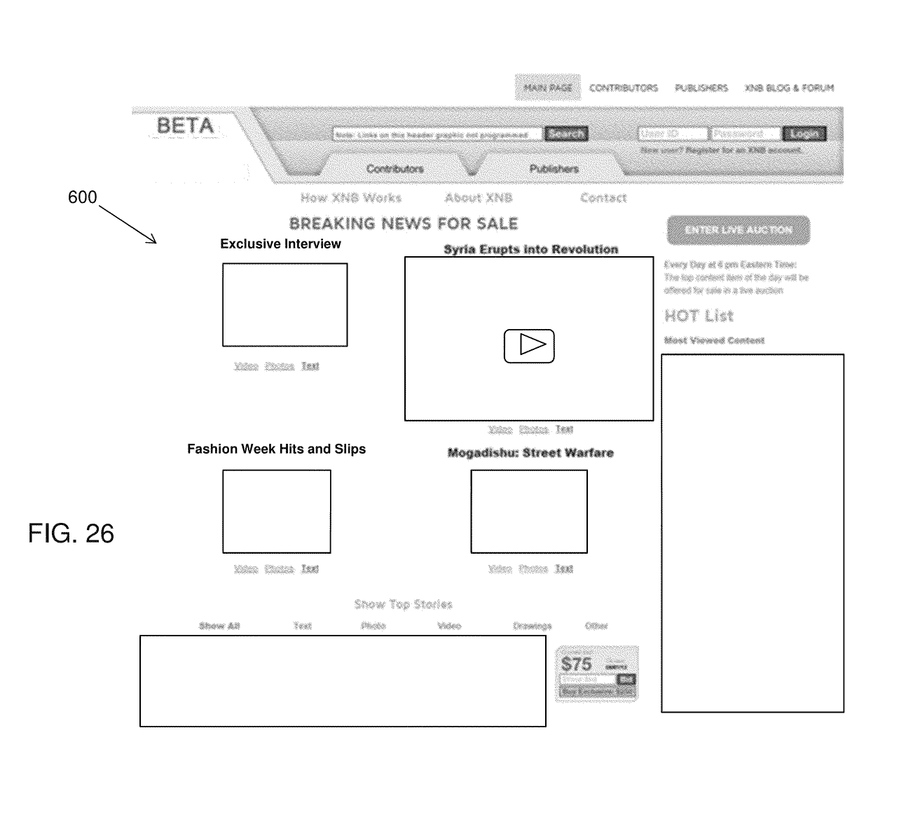

Turning now to FIGS. 26-40, various screen shots are illustrated with exemplary user interfaces that may be provided by the platform 10 to both producers 12 and publishers 14, e.g., via the server application 72.

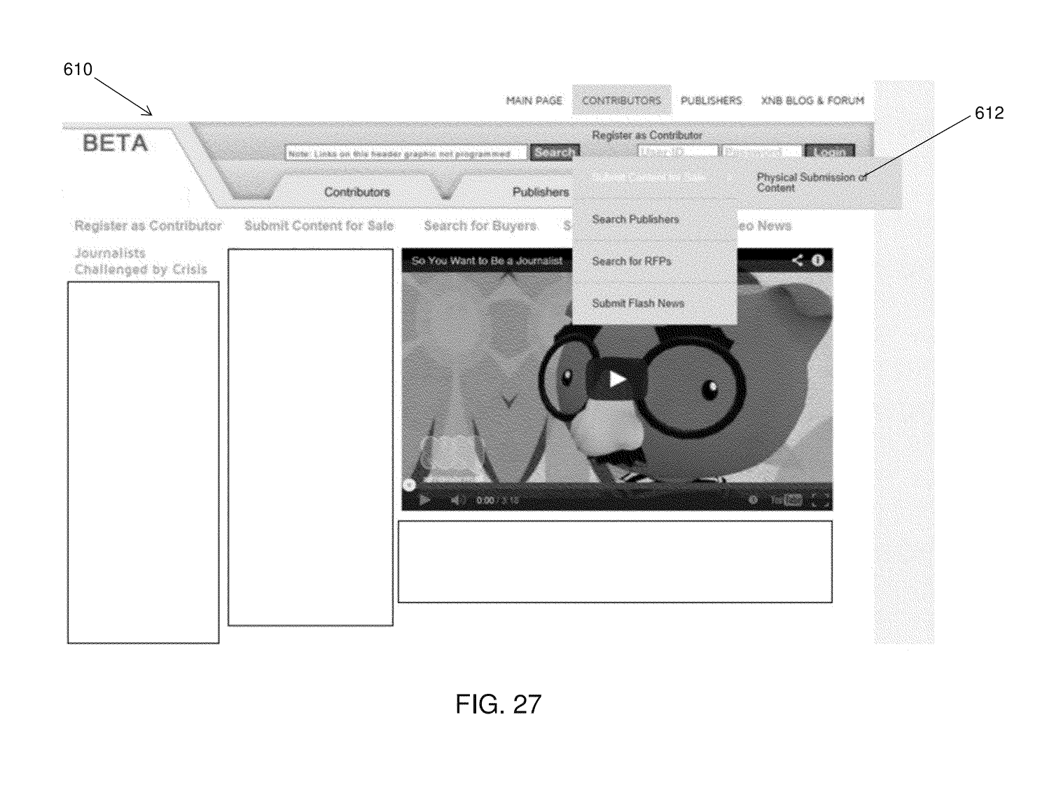

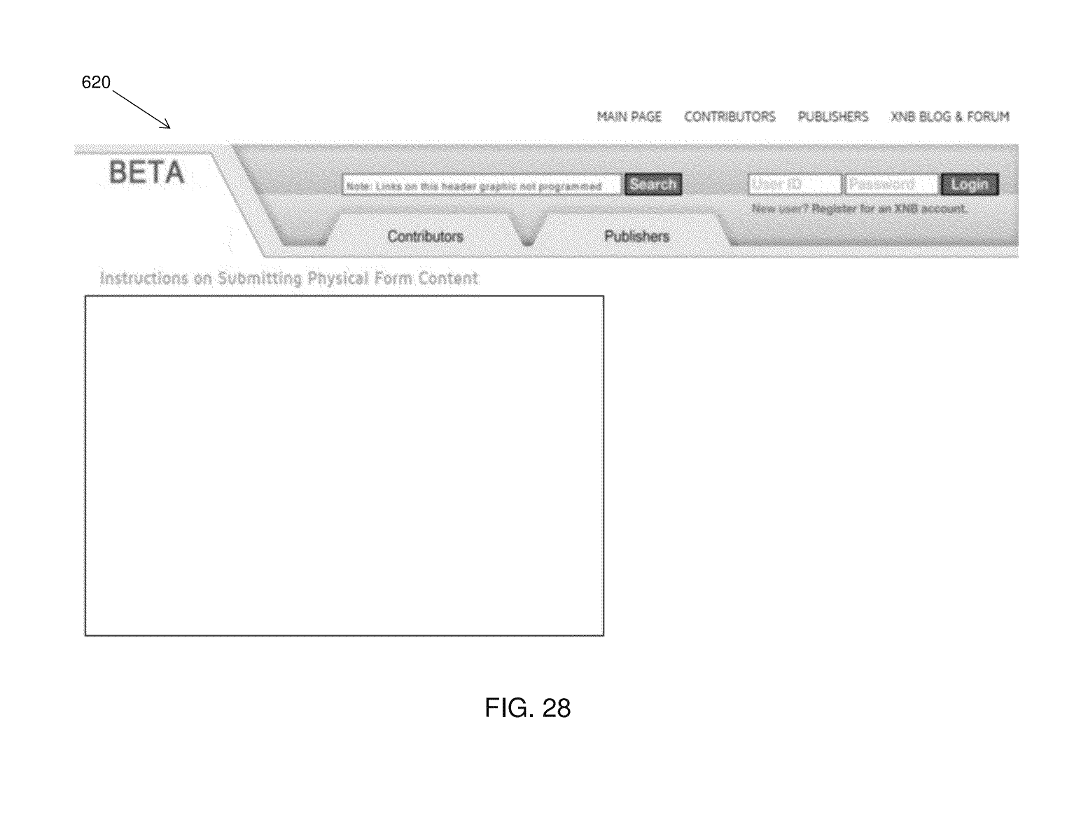

FIG. 26 illustrates a main page 600, which can be provided as a public portal to allow users to register and/or login to the platform 10. Example types of media content are shown in FIG. 26, include breaking news that is for sale, top stories, and a hot list of content that has been viewed the most. The publisher's screen should be limited to potential publishers (e.g. by only showing breaking news etc. after login/registration) to avoid revealing story ideas and pricing to 3^{rd} party producers who are not members of the system 8. Various links are provided that enable users to navigate to producer 12 (contributor) or publisher 14 regions of the web page. FIG. 27 illustrates a screen shot 610 of a list of options that may be selected which relate to producers 12, including options for submitting content, searching publishers 14, searching RFPs, and submitting breaking or “flash” news. Also shown in FIG. 27 is an option 612 related to submitting physical content 18. By selecting the option 612, an instructions page 620 may be displayed as shown in FIG. 28, in which a mailing address and instructions for submitting such physical media are provided. It can be seen that the platform 10 can be adapted to facilitate the incorporation of content through alternative channels to those available directly within the web page.

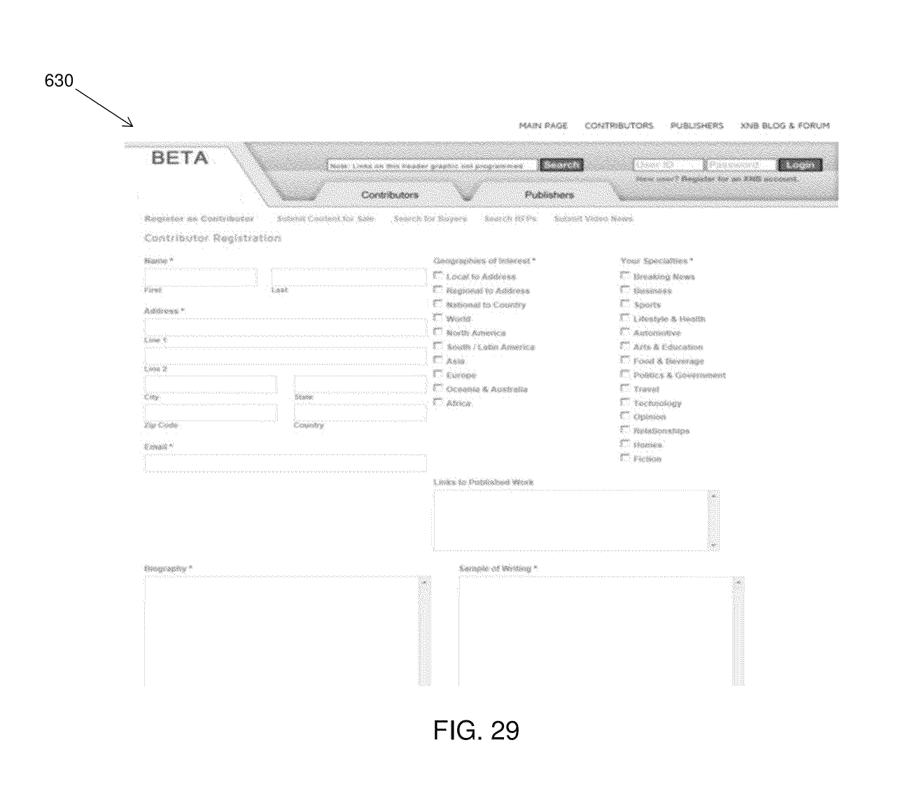

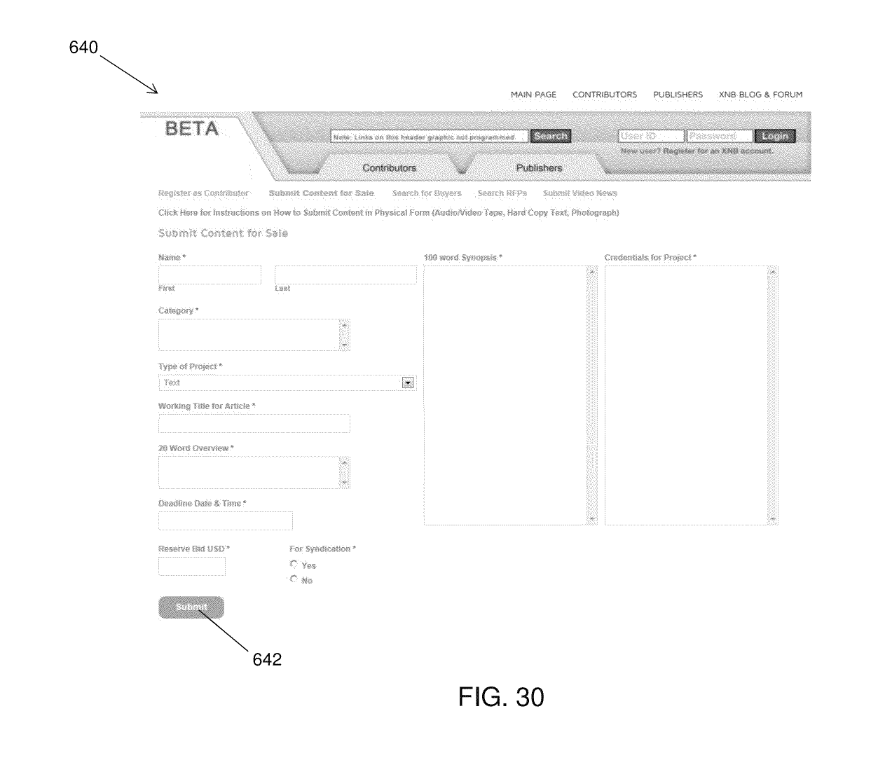

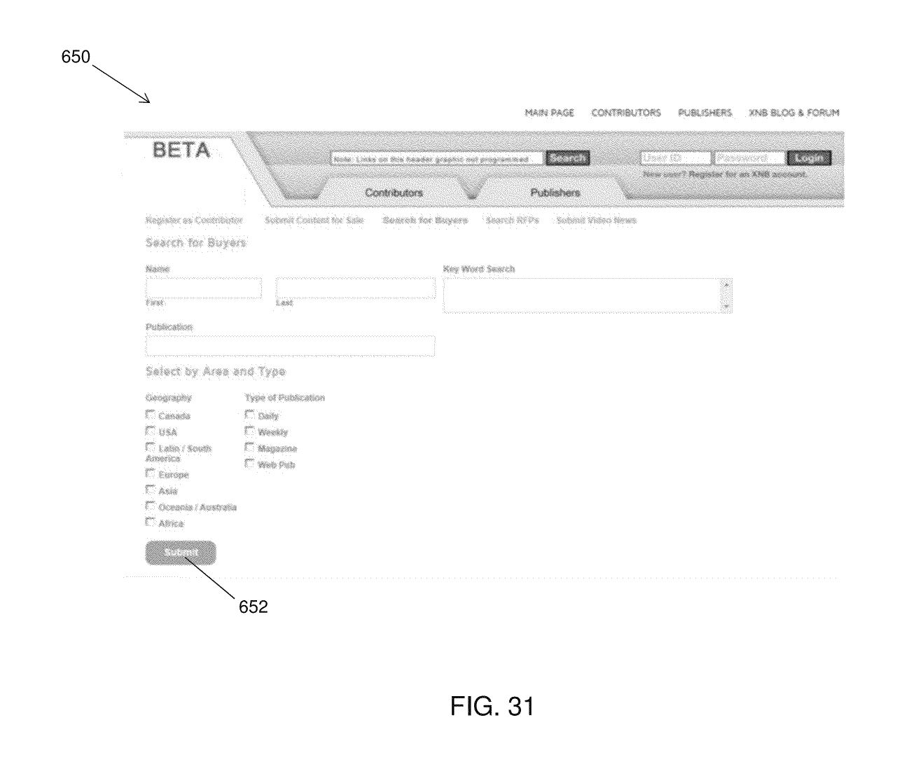

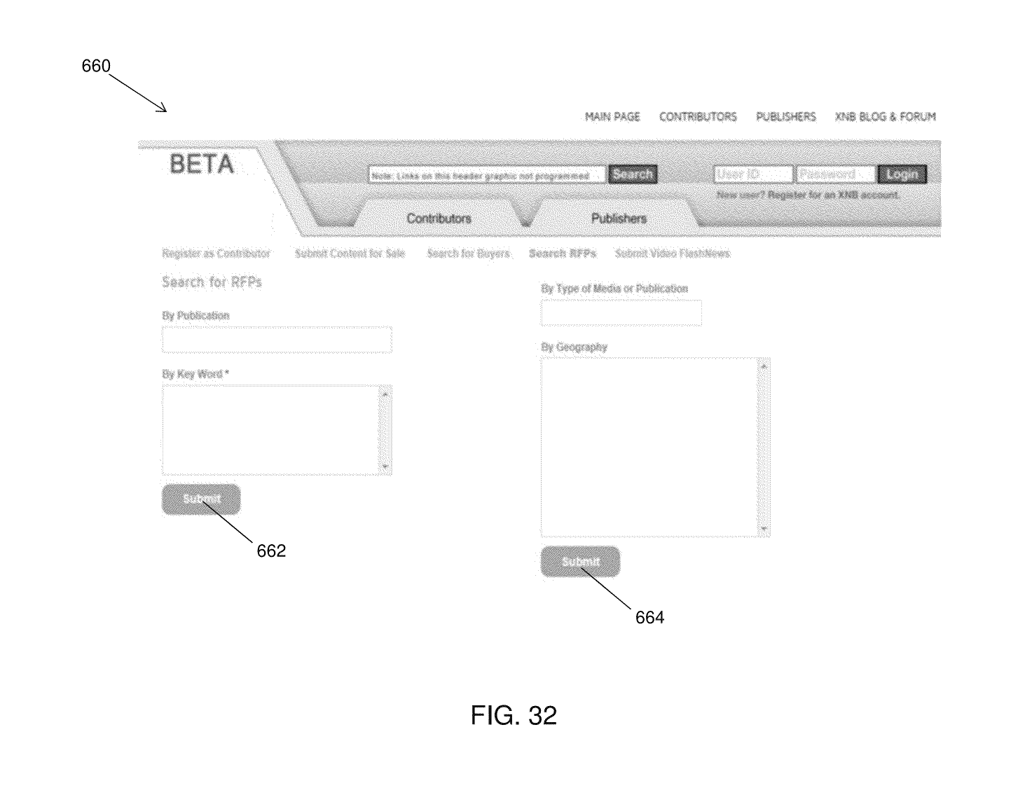

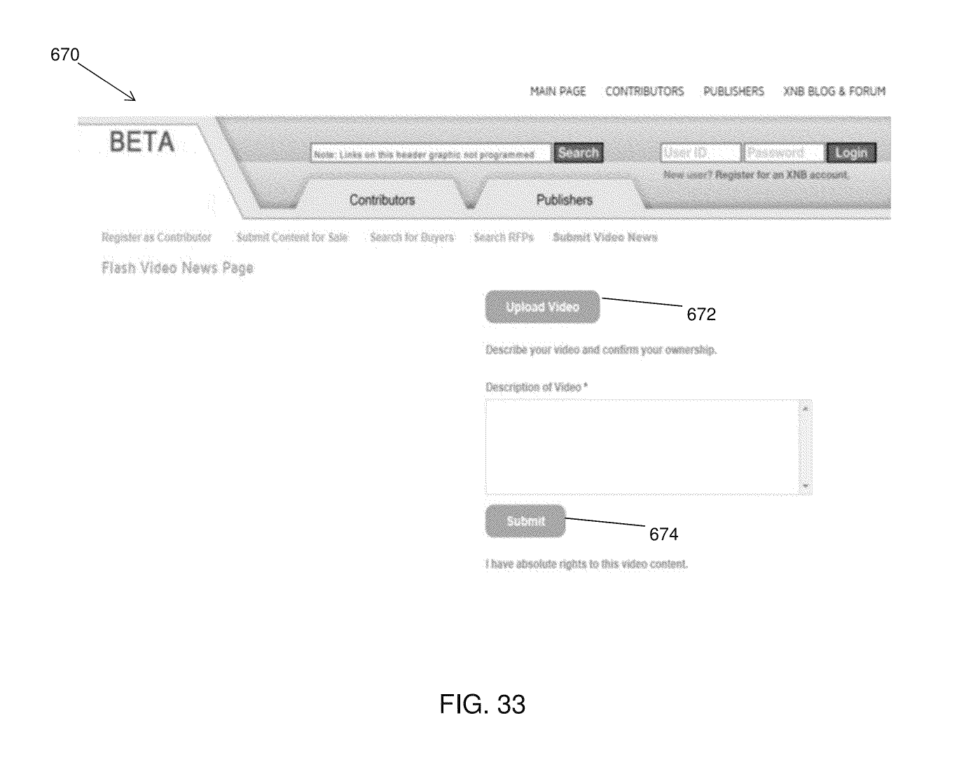

FIG. 29 illustrates a producer registration page 630, which enables a registrant to enter various information used by the platform 10 to register and validate a new producer 12. After registering, the producer 12 can submit content to the platform 10, e.g., using a fillable submission form 640 as shown in FIG. 30. Once the required information and content is added, selecting a submit button 642 uploads the content to the platform 10, which may be added to the content repository 78. The producer 12 may also search for potential buyers, i.e. publishers 14 registered with the platform 10 by accessing a search page 650 as shown in FIG. 31, entering search criteria, and selecting a submit button 652. Similarly, the producer 12 may also search for RFPs that have been generated and submitted by publishers 14 by accessing an RFP search page 660 as shown in FIG. 32 and selecting a relevant submit button 662, 664. It can be seen in FIG. 32 that the producer 12 may be provided with options to search based on the actual publication or a keyword, or by content type or geographical region.

Whereas the page 640 in FIG. 30 enables the producer 12 to submit text-based content, the platform 10 may also provide a different page for uploading media files such as video, for example the upload page 670 shown in FIG. 33. In this example, the upload page 670 includes an upload video button 672 to allow a file to be attached and a description of the video and the video itself to be submitted by selecting a submit button 674. For flash news, as the video uploads, the producer 12 can be given an option to attach a file to describe the video (e.g. an AVI file). The platform 10 may also require the producer 12 to verify that they have rights to the video being uploaded. It can be appreciated that similar pages may be provided for submitting audio files, photos, and text that is included in a scanned publication (e.g. PDF or image).

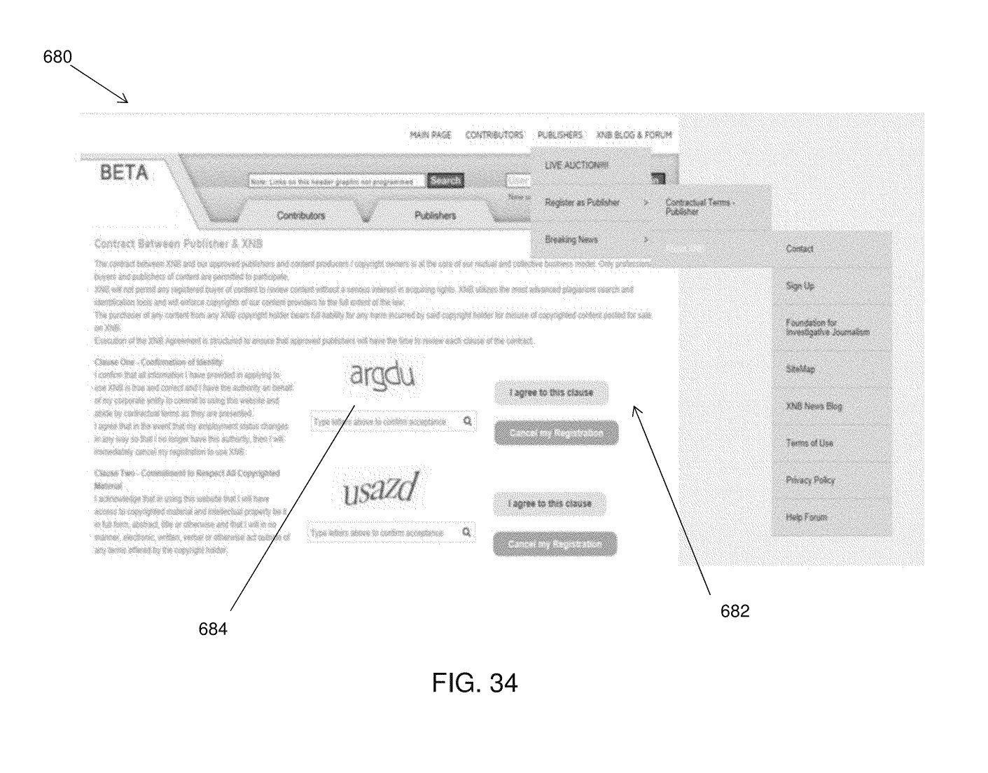

As discussed above, a publisher 14 may be required by the system 8 to agree to particular terms before being registered as a publisher 14 and may also be subjected to other terms on a content-by-content basis. In order to encourage a more thorough review of such terms, it has been found that the platform can present options to actively agree on a clause-by-clause basis as shown in FIG. 34. In the example shown in FIG. 34, each clause in the agreement includes a verification mechanism 684 and a confirmation control 682. In this way, the user interacting with the page 680 is required to enter response to a challenge displayed on the page 680 in association with the clause (e.g. a CAPTCHA mechanism). After entering the response, the user may then agree or cancel the registration by choosing the appropriate button. FIG. 34 also illustrates various options available to publishers 14, including a live auction option, a registration option to access the contractual terms, breaking news options to view breaking news content, and an option to learn more about the platform 10 and/or an organization administering the platform 10.

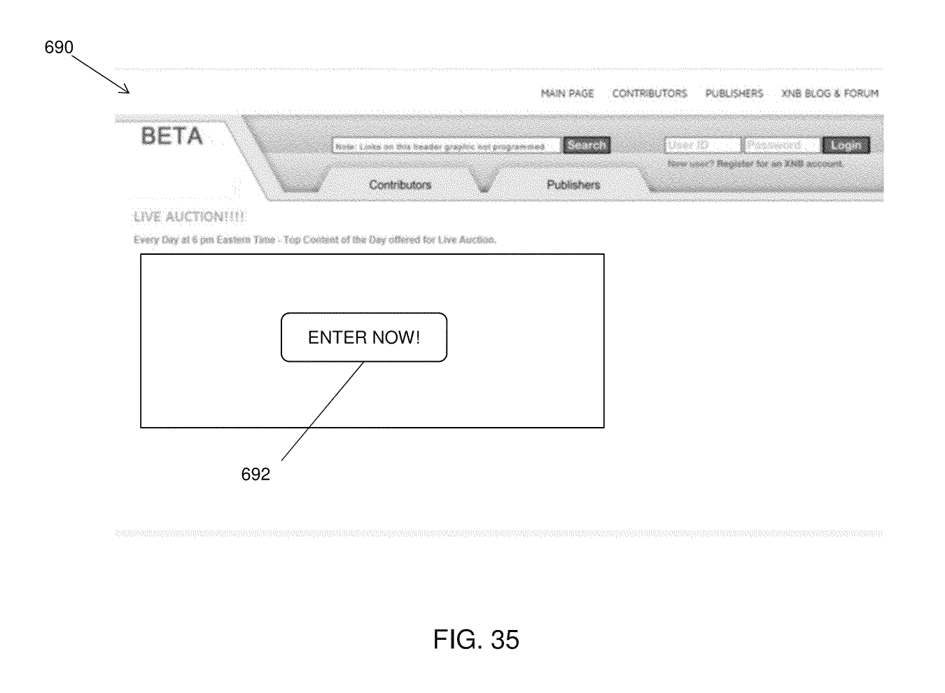

FIG. 35 illustrates a live auction page 690 that may be accessed by a publisher 14 after selecting the live auction option shown in FIG. 34. By selecting a enter now button 692, the publisher 14 can enter the live auction setting, which may be provided using a portal within the live auction page 690 or by another web page or web site, e.g. operated by a third part.

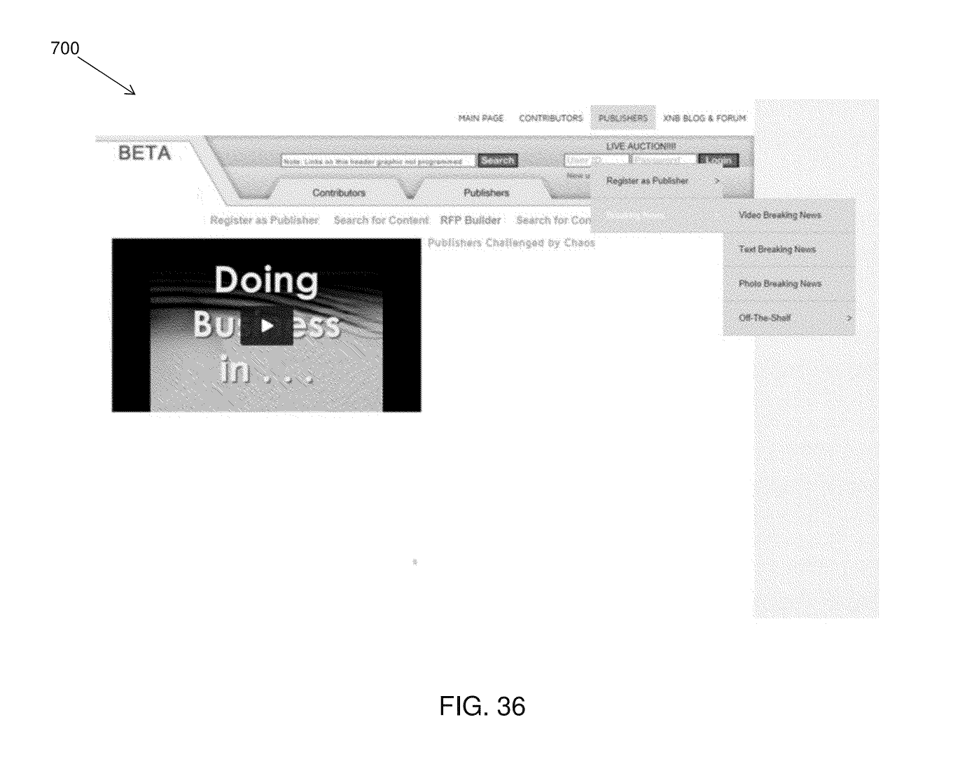

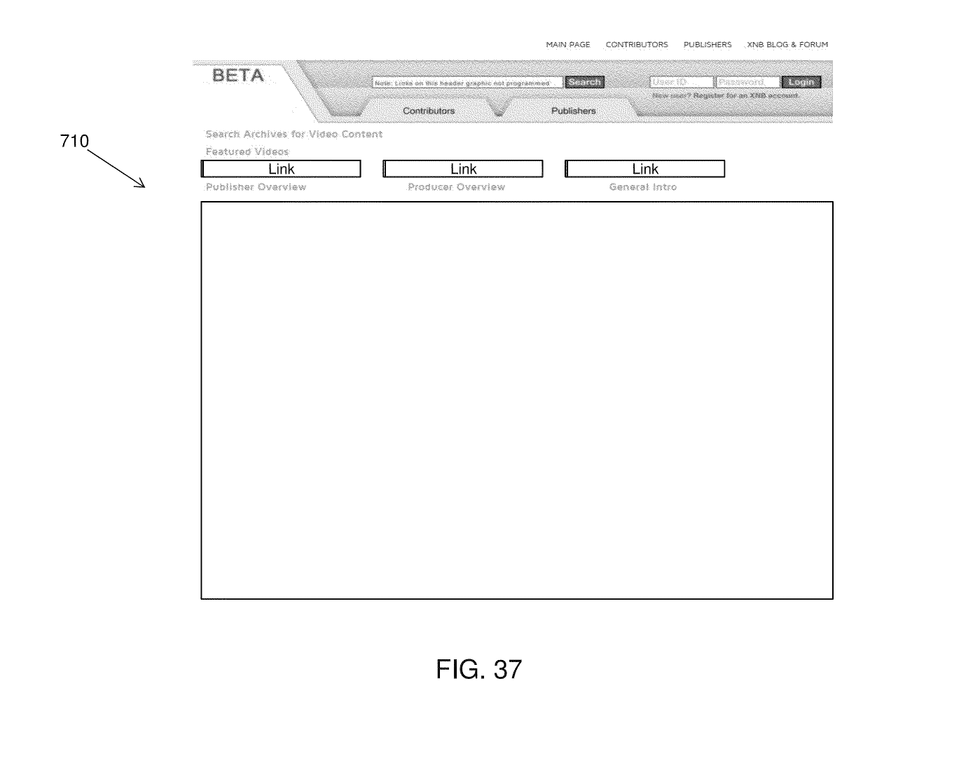

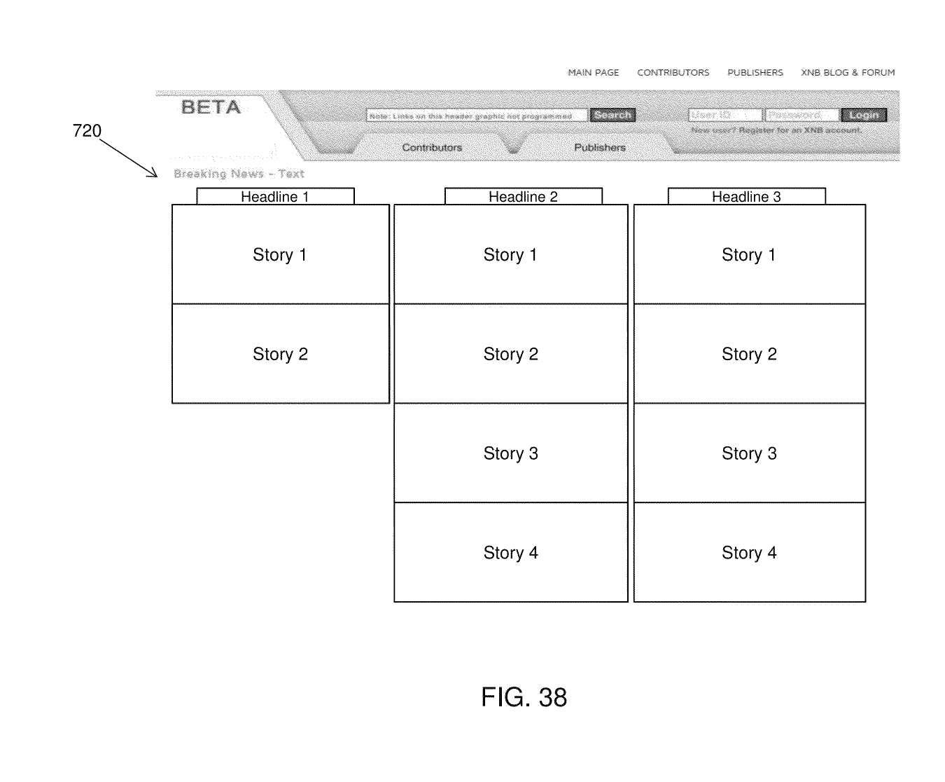

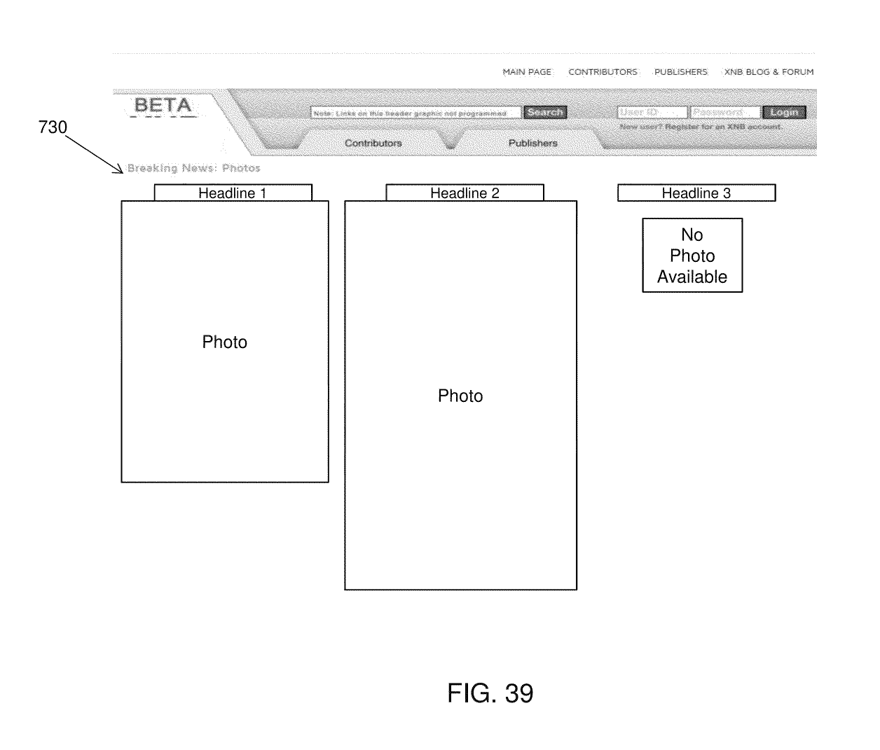

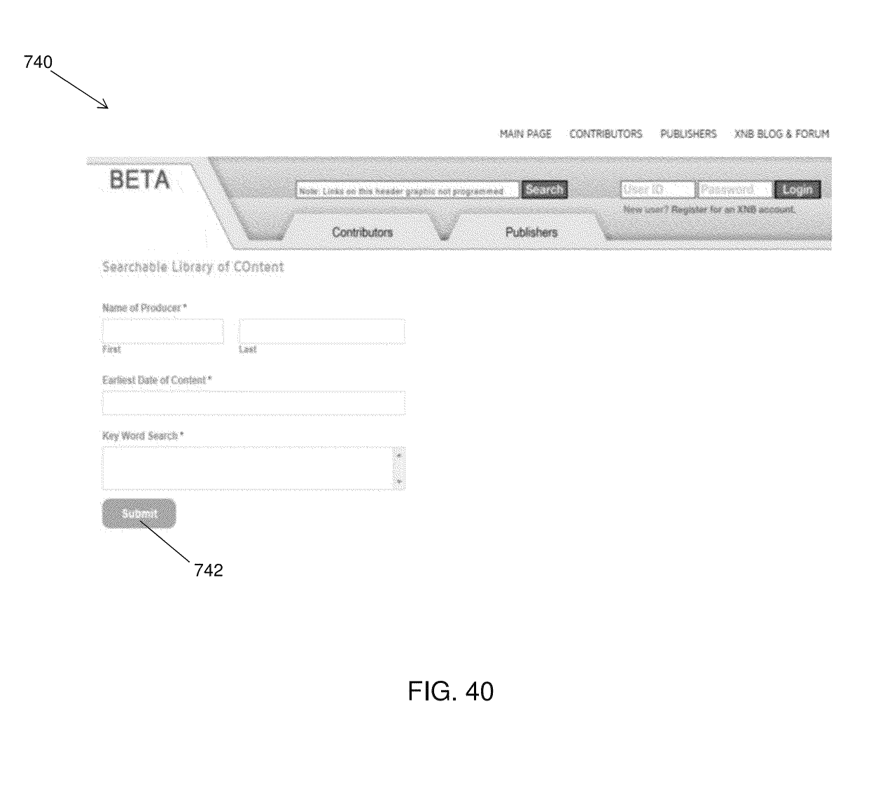

FIG. 36 illustrates options that may be displayed by selecting the breaking news option, including video breaking news, text breaking news, photo breaking news and an off-the-shelf option. FIG. 36 also shows an example of a publisher main page 700 and can be configured to provide links to stand-alone pages of breaking news by type, e.g. print and pictures for print media publishers 14, videos for television publishers 14, etc. FIG. 37 illustrates an example of a video news page 710, and FIG. 38 illustrates an example of a text news page 720, which includes a number of headlines organized with one or more related stories accessible under the respective headline. FIG. 39 illustrates an example of a photo news page 730, which in this example includes photo related to the same headlines as those shown in FIGS. 37 and 38. By selecting the off the shelf option shown in FIG. 36, a publisher 14 is brought to a content search page 740 as shown in FIG. 40. By selecting a submit button 742, search criteria entered into the page are used to conduct a search of the content repository 78.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 8, platform 10, devices 12a, 12b, 14a, any component of or related to the system 8, platform 10, devices 12a, 12b, 14a, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of enabling the publication of media content, the method comprising:
enabling a producer of media content to post at least one media item to an online platform;
providing access to the at least one media item via the online platform to at least one publisher registered with the online platform;
receiving a request from a publisher to obtain rights to a particular media item posted by the producer; and
enabling the publisher and the producer to perform a transaction transferring the rights to the particular media item from the producer to the publisher using the online platform.

2. The method of claim 1, wherein access to the particular media item is provided via an auction, and wherein the request is received in association with the auction.

3. The method of claim 1, wherein access to the particular media item is provided via an option to purchase the particular media item.

4. The method of claim 3, wherein the option to purchase the media item is through syndication of the particular media item subsequent to an unsuccessful auction.

5. The method of claim 1, further comprising enabling a communication to be established between the producer and the publisher via the online platform.

6. The method of claim 1, further comprising enabling the publisher to submit a request for proposal (RFP) for the particular media item, wherein the producer generates the particular media item in accordance with the RFP.

7. The method of claim 1, further comprising providing a contract between the at least one publisher and the online platform and enforcing agreement to the contract during registration of the publisher with the online platform.

8. The method of claim 7, wherein the contract is displayed in a plurality of clauses, each clause requiring a separate corresponding agreement via an input to the online platform.

9. The method of claim 8, further comprising providing a captcha input mechanism with each of the plurality of clauses.

10. The method of claim 1, further comprising providing access to the particular media item in a prescheduled live auction hosted by the online platform.

11. The method of claim 10, wherein the particular media item is subjected to at least one criterion prior to being accepted for inclusion in the prescheduled live auction.

12. The method of claim 1, further comprising enabling physical media content to be made available via the online platform.

13. A computer readable storage medium comprising computer executable instructions for enabling the publication of media content, the computer executable instructions comprising instructions for:
enabling a producer of media content to post at least one media item to an online platform;
providing access to the at least one media item via the online platform to at least one publisher registered with the online platform;
receiving a request from a publisher to obtain rights to a particular media item posted by the producer; and
enabling the publisher and the producer to perform a transaction transferring the rights to the particular media item from the producer to the publisher using the online platform.

14. A system for enabling the publication of media content, the system comprising at least one processor, memory, and at least one communication interface, the memory comprising computer executable instructions for causing the processor to:
enable a producer of media content to post at least one media item to an online platform;
provide access to the at least one media item via the online platform to at least one publisher registered with the online platform;
receive a request from a publisher to obtain rights to a particular media item posted by the producer; and
enable the publisher and the producer to perform a transaction transferring the rights to the particular media item from the producer to the publisher using the online platform.

15. The system of claim 14, wherein access to the particular media item is provided via an auction, and wherein the request is received in association with the auction.

16. The system of claim 14, wherein access to the particular media item is provided via an option to purchase the particular media item.

17. The system of claim 16, wherein the option to purchase the media item is through syndication of the particular media item subsequent to an unsuccessful auction.

18. The system of claim 14, further comprising instructions for enabling a communication to be established between the producer and the publisher via the online platform.

19. The system of claim 14, further comprising instructions for enabling the publisher to submit a request for proposal (RFP) for the particular media item, wherein the producer generates the particular media item in accordance with the RFP.

20. The system of claim 14, further comprising instructions for providing a contract between the at least one publisher and the online platform and enforcing agreement to the contract during registration of the publisher with the online platform.

21. The system of claim 20, wherein the contract is displayed in a plurality of clauses, each clause requiring a separate corresponding agreement via an input to the online platform.

22. The system of claim 21, further comprising instructions for providing a captcha input mechanism with each of the plurality of clauses.

23. The system of claim 14, further comprising instructions for providing access to the particular media item in a prescheduled live auction hosted by the online platform.

24. The system of claim 23, wherein the particular media item is subjected to at least one criterion prior to being accepted for inclusion in the prescheduled live auction.

25. The system of claim 14, further comprising instructions for enabling physical media content to be made available via the online platform.
